(19) United States
(12) Patent Application Publication
(10) Pub. No.: US 2025/0251312 A1
(43) Pub. Date: Aug. 7, 2025

(54) DETECTING THE CAUSE OF ABNORMAL OPERATION IN INDUSTRIAL MACHINES

(71) Applicant: PAUL WURTH S.A., Luxembourg (LU)

(72) Inventor: Cedric SCHOCKAERT, Wiltz (LU)

(21) Appl. No.: 18/857,535

(22) PCT Filed: Apr. 14, 2023
(86) PCT No.: PCT/EP2023/059816

§ 371 Date: Oct. 17, 2024

(30) Foreign Application Priority Data
Apr. 22, 2022 (LU) 501866

(51) Int. Cl. G01M 99/00

(52) U.S. Cl. CPC G01M 99/005

(57) ABSTRACT

A computer differentiates parameters to find critical parameters that cause abnormal operation of an industrial machine, where the computer receives and obtains multi-variate time-series that represents the operation of the machine or that serve as reference, the computer identifies a time-series that deviate from the reference at least in a segment, and for activity-specific replacement variations, the computer selects deviating segments within the series according to a particular replacement variation, replaces the deviating segments, and determines an error value, the computer then determines the variation for that the error value has its lowest value and provides the determination as an identification of the critical parameter to the operator of the machine.

### TECHNICAL FIELD

In general, the disclosure relates to industrial machines, and more particularly, the disclosure relates to computer systems, methods, and computer-program products to identify parameters that are critical to the operation of the industrial machines.

### BACKGROUND

An industrial machine that continuously operates as expected is as rare as a perpetual motion machine. Abnormal operation is the consequence of a relatively rare event that is not foreseen and that usually has a negative impact. Therefore, the human machine operators seek to avoid any abnormal operation.

To name only a couple of examples, the machine may suddenly stop, but by looking at sensors, the operator may identify a broken component. In other situations, the machine may still operate, it may still provide a product or the like, but a part of the machine may operate differently from usual.

Experienced operators may listen to the machine and may hear the difference, but for modern industrial machines such a traditional approach would likely fail.

A computer may receive sensor data (and other data) from the machine and may alert the operator, as early as possible. However, a general observation of present or future abnormal operation is not yet a recommendation to the operator to modify the machine (for example, to change a particular parameter). In other words, detecting abnormal operation of the industrial machine is not the same as detecting a cause of the abnormal operation, yet alone to detect the root-cause.

Even worse, a single parameter may deviate from a usual range and may cause other parameters to deviate, this leading to the abnormal operation. The trouble-making parameter may stay undetected.

### BRIEF SUMMARY

The present disclosure relates to a computer-implemented method for differentiating parameters of a particular industrial machine.

A computer applies a computer-implemented method for differentiating parameters of a particular industrial machine. The computer thereby identifies a subset of parameters that are critical parameters (CP) in the sense that they cause abnormal operation of the industrial machine, and/or that they indicate one or more further parameters that cause abnormal operation.

The computer processes multi-variate time-series that are pluralities of single-variate time-series. The single-variate time-series represent the parameters of the particular industrial machine.

In a receiving step, the computer receives a first multi-variate time-series that represents the operation of the particular industrial machine: the operational (multi-variate) time-series.

In an obtaining step, the computer obtains a second multi-variate time-series that has representative samples in correspondence to the first multi-variate time-series: the reference (multi-variate) time-series. The correspondences are variate correspondence (operational and reference multi-variate time-series have common variates) and time correspondence (operational and reference time-series can be synchronized).

In an identifying step, the computer inspects the first multi-variate time-series and identifies two deviating segments (e.g. at least two deviating segments) in that the samples deviate from expected values.

The computer performs calculations that result in a plurality of error values of an error function. Each calculation comprises the steps selecting, replacing and determining.

In the selecting step, the computer identifies one or more deviating segments in a calculation-specific variation.

In the replacing step, the computer replaces the selected one or more deviating segments by the corresponding one or more segments of the second multi-variate time-series. The computer thereby obtains a corrected first multi-variate time-series.

In the determining the error value step, the computer calculates error values as the sum of a first error component (that is related to the corrected first multi-variate time-series and to the second multi-variate time-series) and a second error component that is related to the corrected first multi-variate time-series and to the first multi-variate time-series.

Having determined the plurality of error values, the computer determines the variation with the lowest error value. For that determined variation, the computer selects the one or more variates with the previously selected one or more deviating segments as one or more variates that represent one or more critical parameters. The computer than provides an identification of the one or more critical parameters to an operator of the industrial machine.

Optionally, the computer determines the error value such that the first error component comprises the sum of the squared differences between the corrected first multi-variate time-series and the second multi-variate time-series, and that the second error component comprises the absolute value of the linear difference between the corrected first multi-variate time-series and the first multi-variate time-series.

Optionally, the computer determines the error value such that the first error component comprises the sum of the number of time-slots in which the corrected first multi-variate time-series and the second multi-variate time-series are different.

Optionally, the computer determines the error value such that the first error component comprises the sum of the number of time-slots for single-variates time-series in that the values are binary (i.e., binary time-series).

Optionally, the computer determines the error values such that the first error component comprises the number of corrections in the corrected first multi-variate time-series.

Optionally, the computer determines the error value with the sum of the number of time-slots in that the corrections had been applied by replacing binary values.

Optionally, the first error component comprises a first weight factor and the second error component comprise a second weight factor.

Optionally, the first and second error components each further comprise variate-specific weight factors, with a first group of variate-specific weight factors that are specific to the variates that represent modifiable parameters and with a second group of weight factors that are specific to variates that represent non-modifiable parameters.

Optionally, the one or more critical parameters are cause-of-abnormal-operation parameters.

Optionally, the computer identifies the segments with deviations in the first multi-variate time-series by applying a pre-defined rule, selected from the following: separately for each variate, comparing the single-variate time-series of the first and second multi-variate time-series and identifying deviating segments as segments in that corresponding samples have a value difference above a pre-defined threshold; separately for each variate, comparing the single-variate time-series of the first and second multi-variate time-series and identifying deviating segments as segments in that an integral is above a pre-defined threshold integral; and separately for each variate, comparing the single-variate time-series of the first and second multi-variate time-series and identifying deviating segments according to the derivatives.

Optionally, the computer identifies the deviating segments by processing the first multi-variate time-series by a pre-trained auto-encoder module that establishes a reconstruction of the first multi-variate time-series so that the reconstruction of the first multi-variate time-series takes the function of the second multi-variate time-series.

Optionally, the computer obtains the second multi-variate time-series by processing the first multi-variate time-series by a pre-trained auto-encoder module that establishes a reconstruction of the first multi-variate time-series so that the reconstruction of the first multi-variate time-series takes the function of the second multi-variate time-series.

Optionally, processing the first multi-variate time-series by the pre-trained auto-encoder module comprises to use a use a convolutional auto-encoder.

Optionally, obtaining the second multi-variate time-series is performed by processing historical multi-variate time-series.

Optionally, obtaining the second multi-variate time-series is performed by any of the following: obtaining data from physically the same machine from different time periods, obtaining data from a similar machine, obtaining data from a virtualized machine, obtaining data from an auto-encoder module as a reconstruction of the first multi-variate time-series, and applying pre-defined rules.

Optionally, updating the second multi-variate time-series is performed for repetitions of the steps identifying, selecting, replacing, and determining.

A computer program product which, when loaded into a memory of a computer system and executed by at least one processor of the computer system, causes the computer system to perform the steps of the computer-implemented method.

A computer system comprises a plurality of modules which, when executed by the computer system, perform the steps of the computer-implemented method.

The computer system can be used to differentiate parameters of a particular industrial machine to identify a subset of parameters that are critical parameters (CP) that cause abnormal operation of the industrial machine.

### BRIEF DESCRIPTION OF THE DRAWINGS

Embodiments of the present disclosure will now be described in detail with reference to the attached drawings, in which:

FIG. 1 illustrates an industrial machine and a computer;

FIG. 2 illustrates the industrial machine and the computer with further details;

FIG. 3 illustrates a simplified overview to a computer-implemented method to identify one or more critical parameters that cause abnormal operation of the industrial machine;

FIGS. 4 and 5 illustrate multi-variate time-series that represent pluralities of machine parameters;

FIG. 6 illustrates the conceptual difference between time-series that are related to different machine roles;

FIG. 7 illustrates a multi-variate time-series with a deviation in one of the single-variate time-series;

FIG. 8 illustrates the multi-variate time-series of FIG. 7 with a further deviation;

FIG. 9 illustrates aspects and details to determine an error value of an error function;

FIG. 10 illustrates a formula for an error function by way of example;

FIG. 11 illustrates replacement variation as a tool to identify a particular error value among a plurality of values;

FIG. 12 illustrates a method flow-chart of the computer-implemented method;

FIG. 13 illustrates the optional use of an auto-encoder to detect deviating segments in time-series;

FIG. 14 illustrates the method flow-chart of FIG. 12 for the computer-implemented method with an optional approach to update references;

FIG. 15 illustrates time-series for calculating the error function in a scenario with binary data;

FIG. 16 illustrates variate pre-processing, by showing an adapter;

FIG. 17 illustrates variate pre-processing, by showing image data;

FIG. 18 illustrates variate pre-processing by data aggregation; and

FIG. 19 illustrates a generic computer.

### DETAILED DESCRIPTION OF EMBODIMENTS

### Overview to Industrial Machines and to Parameters

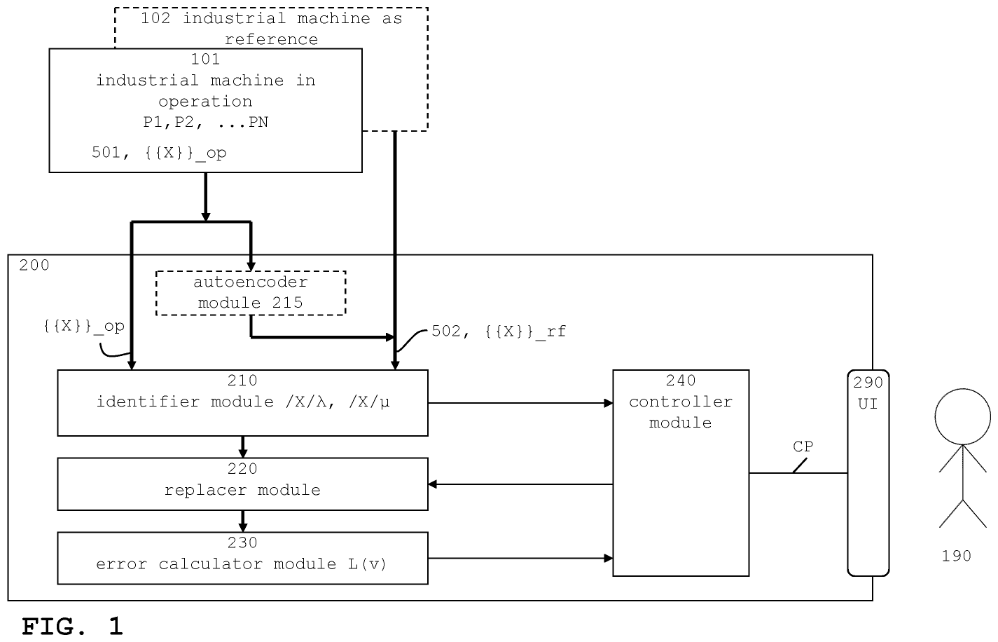

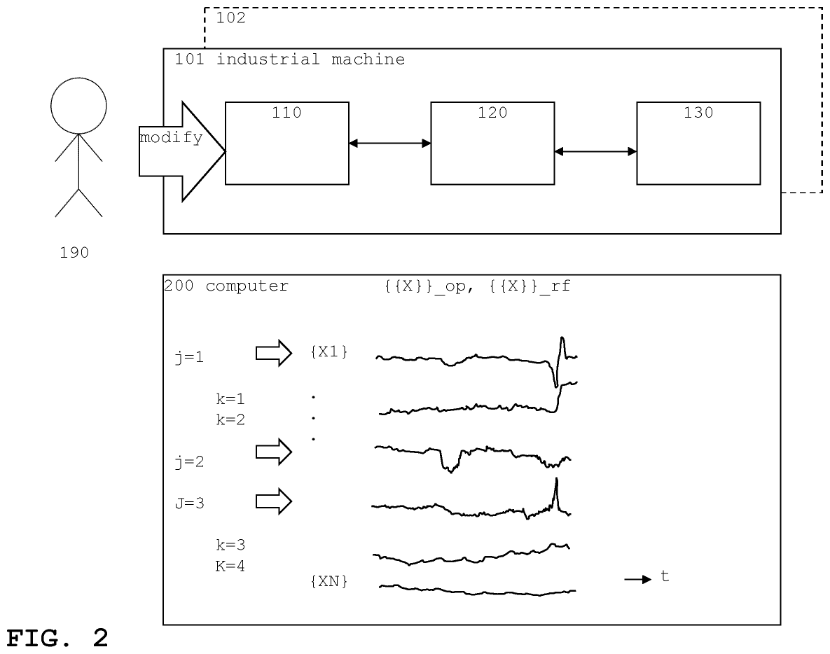

FIGS. 1 and 2 both illustrate industrials machines 101 and 102, and illustrate computer 200. Simplified, machine 101 may not operate as expected, and in view of time, the following scenarios can be differentiated:
Machine 101 may show abnormal operation at the present time, and computer 200 assists operator 190 to let machine 101 resume normal operation.
Machine 101 may show abnormal operation in the future (for example, at a predictable point in time), and computer 200 assists operator 190 to identify appropriate measures to prevent abnormal operation.
Machine 101 may have shown abnormal operation in the past, and computer 200 may assist operator 190 in identifying the cause.

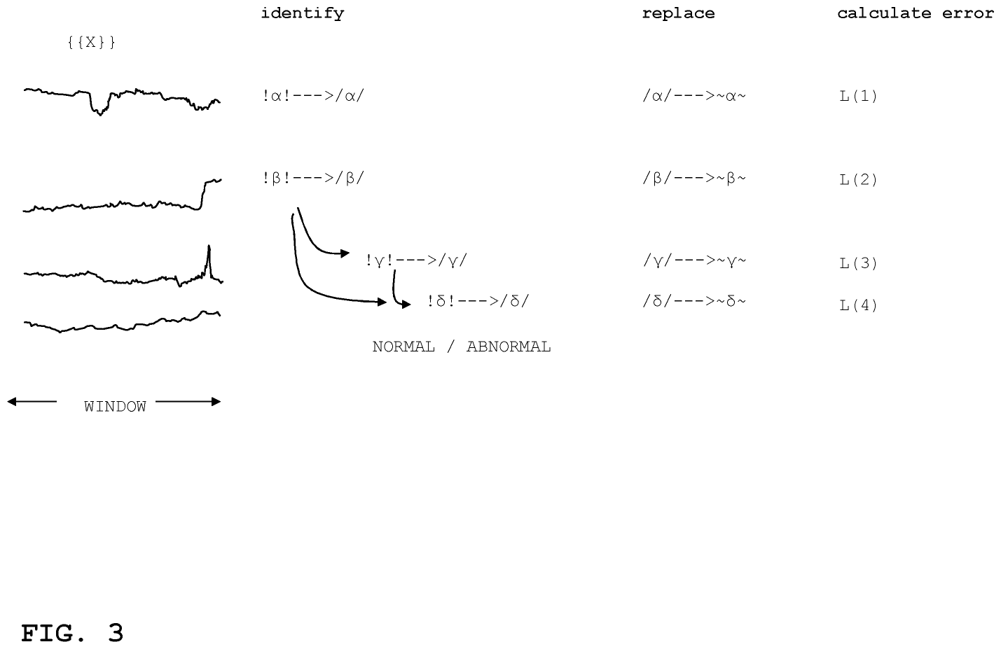

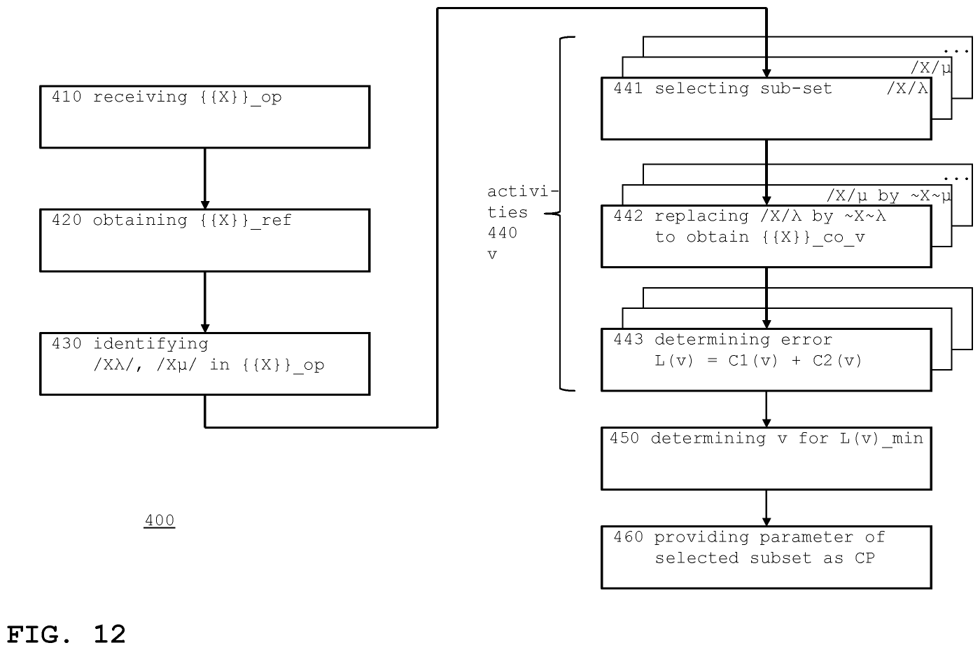

For a high-level perspective, it is convenient to also look at FIGS. 3 and 12: Computer 200 executes a computer-implemented method (reference 400 in FIG. 12) for differentiating parameters of (particular) industrial machine 101, with identifying a subset of parameters that are critical to abnormal operation of the machine (“critical parameters”, CP). In FIG. 3, the CP is parameter β.

Computer 200 provides the identification of the CP to operator 190, as illustrated via user-interface 290, or otherwise.

The subset can have one or more critical parameters, but for simplicity, the description uses singular (“the critical parameter”).

The critical parameter (CP) is a parameter that
can cause abnormal operation (“cause-of-abnormal-operation” (CAO) parameter), and/or
can indicate a parameter that can cause abnormal operation (“indicator-to-abnormal-operation” (IAO) parameter).

A parameter outside the subset can be a critical parameter indeed, but the critical parameter (i.e., the parameter in the subset, such as subset β in parameter set α, β, γ, δ in FIG. 3) has a relatively higher likelihood to be a critical parameter. In other words, the one or more parameters in the subset are associated with relatively higher confidence to cause the abnormal operation than the parameters outside the subset.

Industrial machine 101 and computer 200 substantially operate at the same time (at least for the present and future scenarios). In other words, the operation time of machine 101 may substantially correspond to the runtime of computer 200 so that the critical parameter CP becomes visible early enough for operator 190 to apply the measures in due time.

As used herein, parameters are characteristics, and parameters have two aspects:
parameters influence the operation of machine 101 (i.e., they are “influencing” parameters), or
parameters indicate the operation of machine 101 for a particular machine component (e.g., machine component 110, 120 or 130 becomes a “critical component”, i.e., they are “indicating” parameters).

Both aspects can be combined, so that some parameters both influence the operation and indicate it. The description differentiates influencing and indicating parameters in view of operator 190. The operator may directly modify an influencing parameter. The operator may identify a particular machine component by looking at the indicating parameters. The operator can then modify the machine component.

In principle, operator 190 can modify parameters (and/or a component) at any time, operator 190 usually modifies the CP (and/or the critical component) so that the machine resumes normal operation.

### Computer

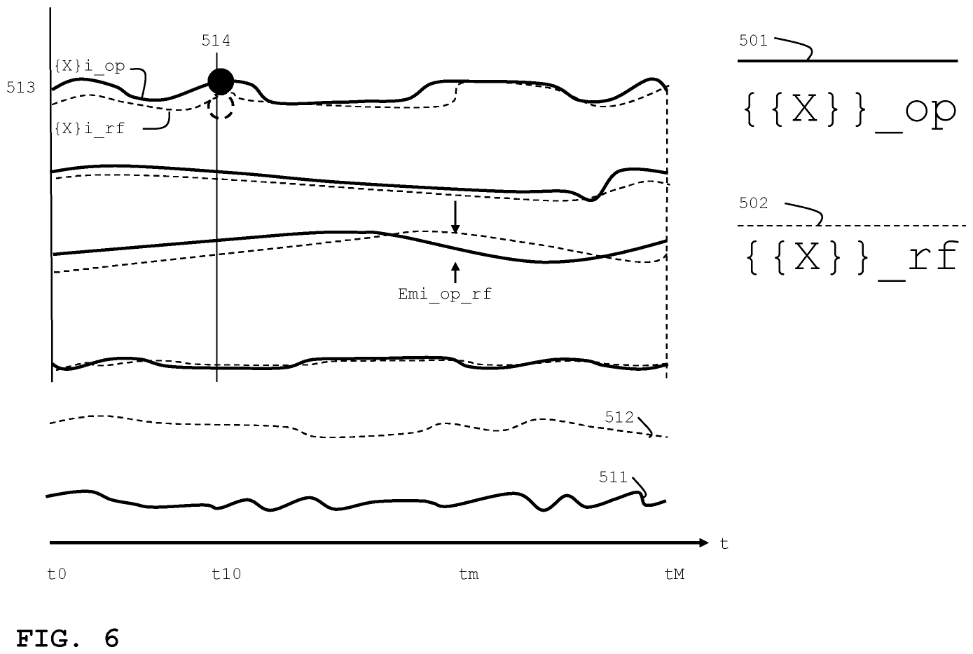

Simplified, computer 200 processes data that represent the parameters (at least some of them). Conveniently, the data are available as a multi-variate time-series {{X}}_op (reference 501 in the time-diagrams of FIGS. 6-9). The skilled person obtains such data, for example, by communicatively coupling machine 101 and computer 200, so that the description does not go into such details.

Computer 200 identifies the critical parameter that is related to abnormal operation. This relation has two aspects:
the critical parameter CP influences the operation such that the machine changes to abnormal operation (at the present time, or at a future/past point in time), or
the critical parameter CP indicates that the machine shows abnormal operation in a particular machine component.

In either aspect, the identification of the critical parameter is of interest for the operator. In the first aspect, the operator may modify the critical parameter so that the machine resumes normal operation. In the second aspect, the operator may further inspect the machine at the particular machine component, and eventually repair or replace the machine component so that the machine resumes normal operation again.

The notation “identify the critical parameter” is simplified. The computer rather differentiates parameters according to likelihoods. With details to be explained, the computer obtains intermediate calculation results (“errors”, L(v)) that represent likelihoods, and a parameter associated with the lowest error (or “highest”, as the case may be) is the critical parameter.

The critical parameter CP has higher likelihood to be related to abnormal operation than other parameters.

Differentiating by likelihood can be advantageous in view of time. Computer 200 executes the method at relatively high speed to have the critical parameter available when resumption to normal operation is still possible (or possible without major interruption). In other words, there is a compromise between
finding the critical parameter as exact as possible (i.e., almost 100% accuracy, e.g., in FIG. 3 to identify β but not a) at relatively high resource usage (computer operation, also the complexity of software), and
finding the critical parameters as fast as possible at an accuracy that allows the operator to modify the parameter (or to repair/replace the machine component).

Identifying the critical parameter may tell the operator that other parameters (such as parameters for that data are not available, “no-data parameter”) may be the cause.

### Deviating Segments

In many cases, the critical parameter deviates (from an expected value) during certain periods of time. In the language of the description, they deviate during a deviating segment of a time-series. The method takes advantage of that.

### Method

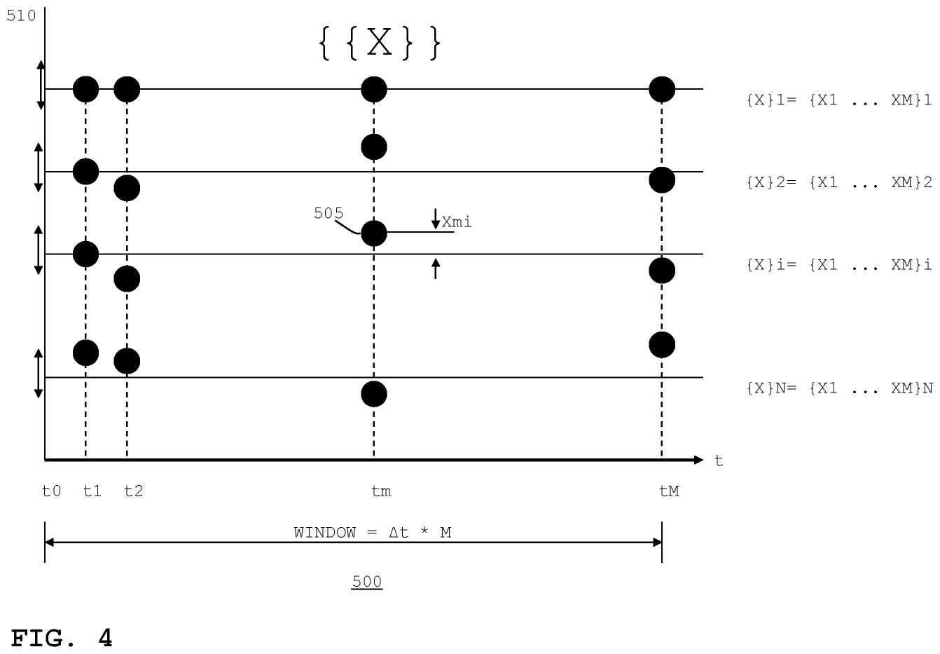

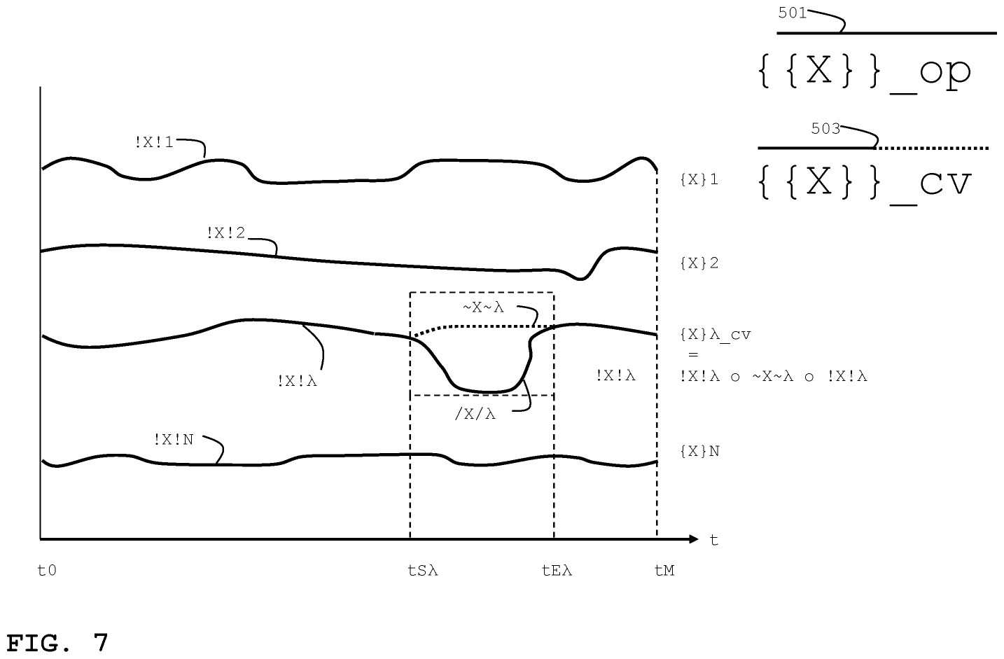

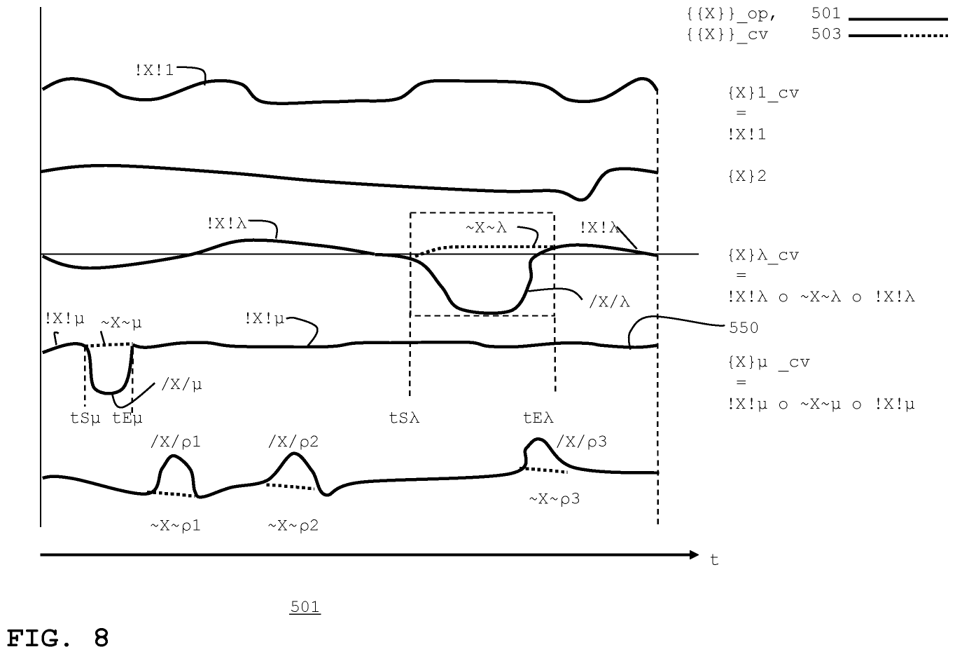

With details to be explained, computer 200 executes method 400 by receiving/obtaining (multi-variate) time-series (steps 410/420 in FIG. 12, cf. FIGS. 4-9) and by identifying deviating segments (step 430 in FIG. 12, also FIGS. 7-8, symbolized by identifier module 210, FIG. 1).

Computer 200 then performs a number of activities 440, serially in a loop, in parallel or by other schemes. The activities are controlled by controller module 240, or otherwise.

The description differentiates the activities by index v (short for “variation”, variation index), with the number of activities being V (i.e., the number of variations).

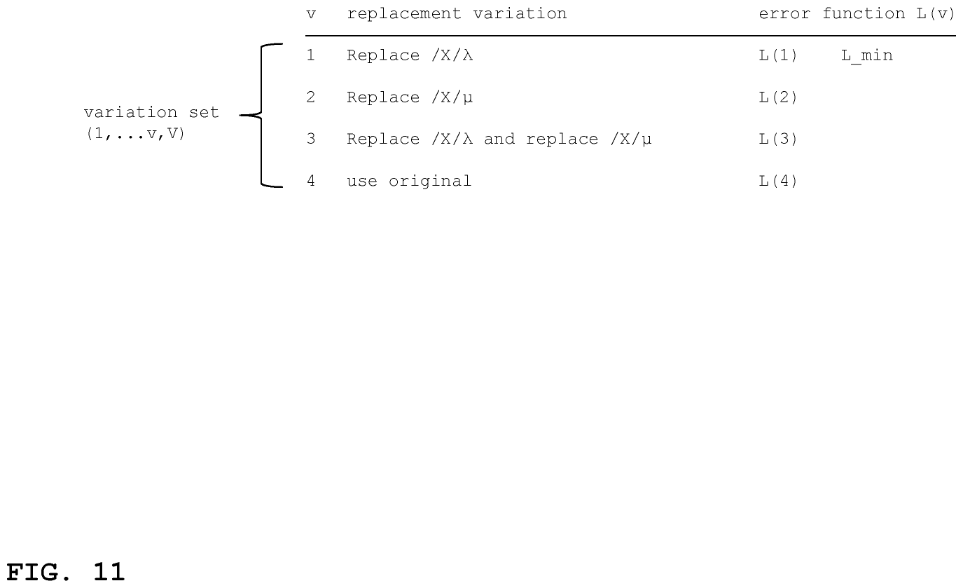

Each activity (v) has the following steps:
selecting and replacing segments (steps 441, 442, i.e., apply variations, by varying segments, also FIGS. 3 and 11), and
determining errors (by calculating, step 443, also FIGS. 3, 9 and 10).

Computer 200 replaces one or more deviating segments by non-deviating segments, according to a pre-defined variation scheme so that each calculation (in step 443) assumes different replacements. The skilled person can identify a suitable scheme, the description symbolizes to replace one segment per variation (in FIG. 3) or to replace one or more segments per variation (in FIG. 11). Other schemes comprise the variation with iterations, with gradients or the like. For example, the skilled person can apply gradient-based optimization so that the error function L(v) does not have to be applied for all variations V.

The figure symbolizes the activity-specific replacement by replacer module 220.

Computer 200 calculates the error values of an error function (L(v), symbolized by error calculator module 230), that are specific for each replacement variation (v).

There is an assumption that the error function L(v) has a minimum value for a particular replacement variation (v), and that the particular replacement (with the minimal error) is a pointer to the critical parameter.

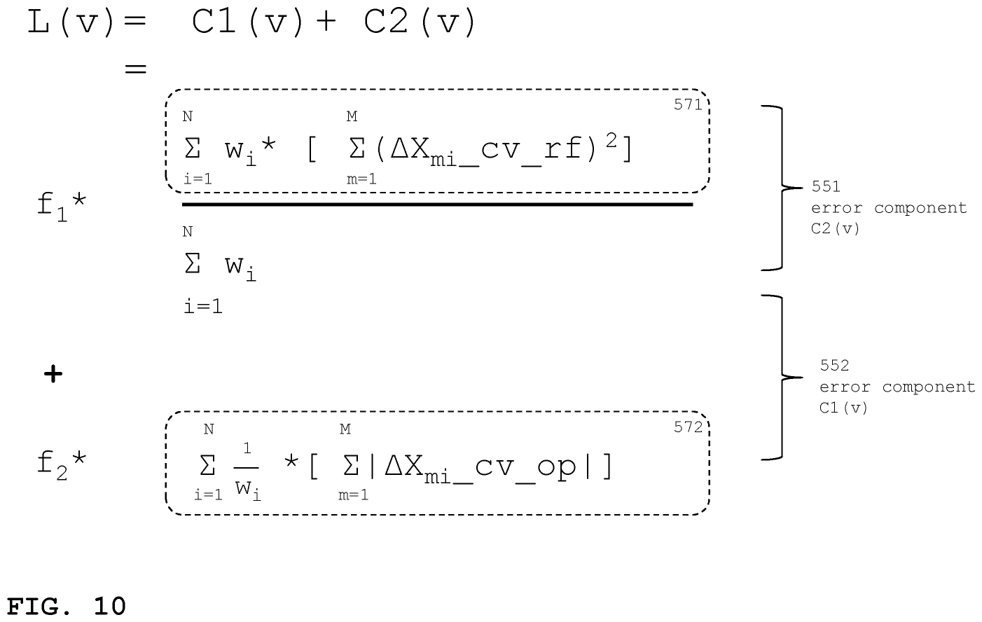

In other words, the computer may optimize the error function L(v) (to minimize it, cf. FIG. 10) and thereby identifies the parameter deviation in question (i.e., the critical parameter).

The calculation of the error function L(v) has some analogy to the calculation of a loss function in a to-be-trained neural network. Training a network requires the variation of weights, but here the segment replacements are varied.

### Writing Convention

Although terms like “abnormal” and “deviation” may be considered as synonyms, the description makes a difference between
the deviation of a parameter (of that machine), and
the abnormal operation of the machine (as a whole).

### Theoretical Example in FIG. 3

A first parameter α may deviate from usual, but such parameter deviation may not cause abnormal operation of the machine. In other words, even if parameter α deviates, the machine still operates normal, a would not be the critical parameter. At a later point in time, a second parameter β may deviate as well and thereby may cause a third parameter γ and a fourth parameter δ to deviate. In consequence of the deviations in γ and δ, the machine no longer operates normally. Computer 200 processes the deviations of α, β, γ and δ and identifies β as the critical parameter.

As there are no further critical parameters, β would be the root-cause parameter for the abnormality, or “RCAO parameter”.

### First Practical Machine Example

A first fictitious machine (not illustrated in detail) should have
a heater coil to heat up water, with the power status of the coil as parameter P1 (e.g., measured by the electrical parameters such as current and/or voltage),
a circuit breaker to interrupt the electrical power to the heater coil, with the ON-OFF-status as parameter P2, and
a thermometer to measure the water temperature, being parameter P3.

In normal operation, the thermometer would detect that the water temperature rises over time, but in abnormal operation it does not. The change in the temperature is not the cause, but the consequence.

As there can be many reasons (i.e., causes) for that, the computer would detect a deviation in P2 as the cause. The computer would present P2 (or variate X2, conceptually the same) to the operator as the critical parameter (CP). The operator may then close the circuit breaker again to resume normal operation.

P2 is an example for an influencing parameter that is modifiable by the operator (and the operator would actually modify it, OFF to ON).

### Second Practical Machine Example

A second fictitious machine (also not illustrated in detail) should have a motor with sensor-supervised bearings. The sensors measure parameters such as temperature and vibration of the bearings, and further parameters indicate the power consumption of the motor. As a broken bearing causes friction (instead of minimizing it), the machine would show abnormal operation in consuming more power than usual. In this example, the parameters indicate aspects of the operation (temperature, vibration, power etc.) but the computer would identify deviating temperature and vibration of a particular bearing, i.e., as critical parameters.

Temperature and vibration are examples for indicating parameters, but the indication comprises the identification of a particular bearing (assuming the computer receives the parameters separately for each bearing). The status of a bearing is a no-data parameter, but the status can be derived (by the computer applying pre-defined rules, by the computer applying experience from machine learning, by the operator using experience knowledge, etc.). Operator 190 can eventually find out that the bearing is broken and can replace it.

Abstraction from Semantics

Although the description explains the simplified fictitious machines with semantics, the computer processes the representations of the parameters by numeric values (in the time-series), substantially without semantics, and without considering the physical relations between the parameters. In other words, the computer does not apply rules that reflect the physical relations (e.g., heater with current heats up the water; the friction of a bearing in view of temperature and vibration). Disregarding semantics may be advantageous because the computer would not have to use rules that represent relations between the parameters.

Variates that Represent Parameters

The description differentiates parameters in the machines from variates in the computer. As used herein, variates are parameter representations by the computer, with variate X1 representing parameter P1, variate X2 representing P2, variate X3 representing P3, and so on (variate Xi representing parameter Pi).

The computer cannot modify parameters (this is the task for the operator), but the computer can apply variations to the data (i.e., vary the variates, steps 441, 442).

Identifying variations (in the variates) that lead to relatively small errors values (function L(v), step 443) also identifies the critical variate (or critical variates), with one-to-one representation back to one or more critical parameters (the critical variate represents the critical parameter).

By identifying the critical parameters, computer 200 indicates the status of industrial machine 101 as a technical system. Based on that, operator 190 can actively modify the critical parameters accordingly, or—for indicating parameters—can repair or replace the machine component that causes the abnormal operation.

### Cause of Abnormal Operation, Root Cause

It can be desired to evaluate the parameters to identify one or more cause-of-abnormal operation (CAO) parameters. One of these CAO parameters can be the root (R) cause (C) of abnormal (A) operation (O), i.e., the RCAO parameter.

The first fictitious machine may have further parameters, such as a parameter that indicates a short-circuit (that would trigger the breaker to go OFF). The short-circuit could be a CAO parameter. The second fictious machine may show above-threshold temperature and vibration are critical parameters, being indicators. The cause may be different (e.g., excess load to let the bearing break), but knowing the critical parameters invites the operator to look at the corresponding machine components without losing much time. This approach increases the chances for the machine to resume normal operation.

### Deviations in View of Reference Data

FIG. 1 illustrates industrials machines 101 and 102 in combination with computer 200. Machines 101 and 102 are of the same type (i.e., machines use corresponding parameters).

To stay with the first example, both machines would have a heater coil, a circuit breaker and a thermometer, and would have sensors to parameters P1, P2 and P3 with variates X1, X2 and X3, respectively. In the second example, machine components could be differentiated into machine components 110, 120, 130 (e.g., motor 110 and bearings 120, 130). Sensors and other data sources (such as regarding power consumption) are not illustrated.

The machines are differentiated by performing different roles:
Industrial machine 101 is the machine that may show abnormal operation and for that one or more critical parameters (CP) have to be identified, if possible CAO parameters and the RCAO parameter.
Industrial machine 102 (“reference machine”) has provided (or is providing) reference data to the operation of machine 101.

It is convenient to assume that machine 101 is currently operating (i.e., “machine in operation”) so that computer 200 identifies the critical parameters substantially in real-time, to allow correction so that machine 101 can continue to operate normally (cf. the “present time” scenario mentioned above).

### Reference Data as Replacement Reference

Reference data serve the main purpose to provide replacement segments (cf. replacing step 442).

In view of the replacement, the description applies a simplification: reference data are discussed as reference (multiple-variate time-series {{X}}_rf) that means as data in the same format (i.e., multi-variate time-series) as the {{X}}_op.

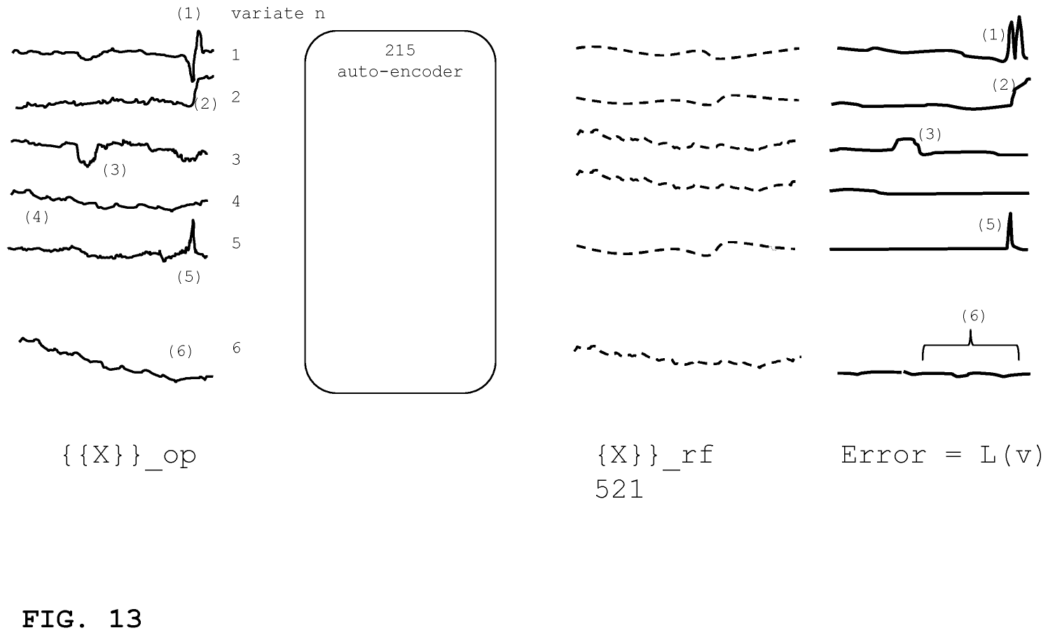

The skilled person can obtain the reference, such as {{X}}_rf in a variety of implementations. Machine 102 can be regarded as a physical machine, or as an equivalent that is implemented otherwise, such as by computers (e.g., by computer 200, or by a different computer).
In a 1st implementation scenario, machines 101 and 102 are physically the same machine that act in the different roles at different times. The machine (acting as 102) has provided {{X}}_rf as historical data. Usually there would be a collection of such data.
In a 2nd implementation scenario, machines 101 and 102 are physically separate machines, that belong to a fleet of similar machines.
In a 3rd implementation scenario, machine 102 is a machine that is virtualized by a computer. The skilled person is familiar with the concept of having a digital twin (machine 101 the original, machine 102 the twin). The digital twin would provide {{X}}_rf.
In a 4th implementation scenario, computer 200 uses auto-encoder module 215, details are explained in connection with FIG. 13.
In a 5th implementation scenario, computer 200 implements predefined rules. For example, the computer can detect that a single-variate time-series starts deviating (i.e., has a deviating segment) when a variate value (such as a temperature) exceeds a pre-defined threshold, and the computer can identify the end of deviating if the variate value goes below the threshold. The skilled person can apply the such and other rules otherwise (e.g., different thresholds to reflect hysteresis).

### Further Purpose as Expectation Reference

Reference data may serve the further purpose to provide values that are expected for individual parameters. In other words, reference data provide an expectation reference. When a single parameter does not have a value as expected, the parameters show a deviation.
In the first example, the circuit breaker is expected to be ON (or conductive) all the time, but the parameter P2 deviates when the breaker goes OFF.
In the second example, parameters such as temperature, vibration, and power consumption are expected to be below certain thresholds. Individually they can deviate.

### Further Purpose as Normal Operation Reference

Reference data may serve the further purpose to identify abnormal operation. A deviation of a single parameter alone does not mean abnormal operation (of the machine).

The skilled person can define rules by which abnormal operation is detected. In the first example, the circuit breaker (P2) going OFF would lead to abnormal operation, the other parameters P1 and P3 do not matter. In the second example, abnormal operation could be defined for either temperature or vibration above threshold, in combination with excess power consumption.

It may be advantageous (such as to save computation resources) to let computer 200 execute method 400 when abnormal operation has been detected.

It is not required that operator 190 is aware of machine 101 showing abnormal operation.

### Changing Reference Data

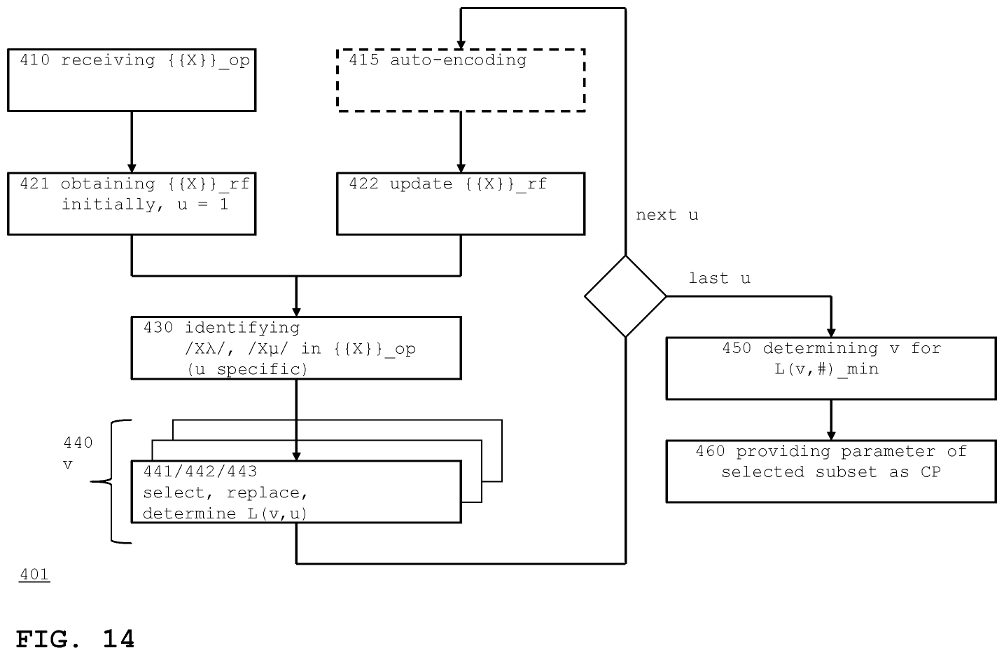

In case that a parameter (or a component) has been modified, for any reason (such as to resume normal operation, in the process of maintenance or the like), the skilled person can update the reference data as well. It is also possible to update (or refresh) reference data during while the computer performs the method. Details for such an optional approach will be explained below in connection with FIG. 14.

### Simplification

The description applies a further simplification. As used herein, multiple-variate time-series {{X}}_rf
provides replacement segments (replacement reference),
provide expected values (expectation reference), and
provide the input to determine abnormal operation (normal operation reference).

The skilled person can use separate references, for these 3 functions.

### Parameter Details, Taxonomy

FIG. 2 illustrates machines 101 and 102 with interacting machine components, here symbolized by blocks 110, 120, 130. Arrows between the blocks symbolize dependencies between the machine components.

Parameters can be differentiated according to the location of the machine component (i.e., according to the component topology):
Input parameters characterize material, energy etc. that the machine receives at an input or intake (such as the characterization that the machine processes water or some other material).
Process parameters are characterized by their relation to particular process step, such as the processing of particular materials, the consumption of energy and other resources (such as electrical power or thermic power), the emission of substances (comprising CO2) and others.
Output parameters characterize products (or intermediate products). For example, output parameters characterize the quantity and quality of a product (in the simplified example: hot water and its temperature).

Parameters can further be differentiated by the availability of the operator to modify them. There are two categories:
modifiable parameters, and
non-modifiable parameters.

Categorizing the parameters can optionally support the application of different weights in the determination of an error function (cf. below, FIG. 10, and FIGS. 12, 14, step 443).

In the above first example, the operator may not be able to replace a broken heater coil, but may be able to manually turn the breaker ON (of course, after doing some routine checks), and the operator may use an alternative sensor to measure the water temperature.

Parameters that can be modified by operator 190 (of machine 101, 102), are modifiable parameters, or “actuator parameters”, otherwise they are non-modifiable parameters, or “machine characterizers”. In other words, the parameters are active parameters (modification possible) or passive parameters (modification not possible). The figure uses index j, in the example from j=1 to J=3.

The corresponding variates (i.e., the representations of the parameters) are “modifiable variates” and “non-modifiable” variates. It is however noted that the operator modifies parameters, not variates.

The distinction between modifiable and non-modifiable depends on the type of machine and on other factors.

Some modifiable parameters may be modifiable only indirectly. Directly modifiable parameters can be input parameters (such as material at the input of the machines such as raw material), process parameters of the machine (such as the operational mode of the machine, stand-by, full-operation, etc.), and others.

The figure illustrates modifiable parameters (and modifiable variates) by arrow symbols. It is noted that operator 190 may modify, for example, the operation of machine component 110 (cf. the arrow), and machine component 110 may act on machine component 120 and so on.

Indirectly modifiable parameters can be, for example, the vibration of the machine (measured by sensors), the environmental temperature or other temperature (measured by thermometers), humidity and others.

The figure shows non-modifiable parameter by index k, in the example from k=1 to K=4.

Below the machines, the figure illustrates a multi-variate time-series {{X}} by a time diagram (time t illustrated from left to right). The figure is much simplified, and real machines have much for than N=6 parameters (N=J+K).

The skilled person can identify further parameters, and the description therefor refers to parameters just be way of examples.

Parameters can further be differentiated into groups, a first parameter group may be related to machine component 110, a second group to machine component 120 and so on.

### Abnormal Operation

In the first example, the circuit breaker goes OFF only in situations of a threshold-exceeding electrical current, but would normally not go ON automatically (in difference to a switch that would be part of a control loop).

Abnormal operation (and the deviation in a single parameter) can lead to a change of one or more parameters. It does not matter if the parameters modifiable or not. As the computer represents the parameters by variates, the computer can detect anomalies by processing the variates.

Abnormal operation (and the deviation in a single parameter) can be differentiated according to the impact to the process. A sensor or measurement instrument may provide an incorrect variate. In the first example, the thermometer may be broken (or incorrectly calibrated, or incorrectly identified by the computer, etc.) so that variate X3 may not represent the (otherwise normal) parameter P3 correctly.

In a typical scenario, operator 190 modifies one of the (modifiable) parameters, the critical parameters. There is a preference to modify the CAO parameters, and—if possible—to modify the root-cause parameter (RCAO parameter).

FIG. 3 illustrates a simplified overview to the computer-implemented method to detect one or more critical parameters.

As used herein, the description uses slashes // for parameters that deviate, and the description differentiates them by small Greek letters. Arrows indicate causes, but computer 200 does not know them a priori.

Variate Xα changes but the parameter λα does not influence other parameters. After a while, parameter β (variate Xβ) deviates and cause deviations in γ and in δ.

The computer identifies 4 deviations /X/α, /X/β, /X/γ, /X/δ and—for computer activities only and without interfering with the industrial machine-modifies the time-series (i.e., {X}β etc.) by replacing the deviating segments // by replacement segments ^{˜˜}. The replacement segments ^{˜}X^{˜}α, ^{˜}X^{˜}β, ^{˜}X^{˜}γ, ^{˜}X^{˜}δ stand for sequences that are taken from non-deviating time-series (e.g., from the replacement reference).

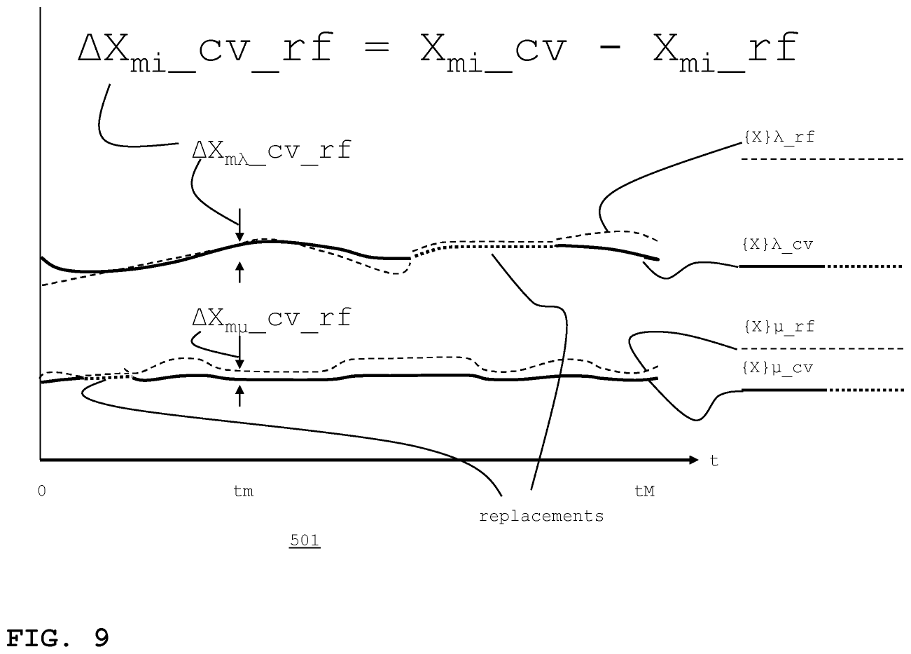

The computer calculates error values (for the multi-variate time-series, substantially all variates, also the non-changed ones, details in FIGS. 9-10). The change in Xβ has the highest impact so that parameter β (i.e., Pβ in the above notation) is identified as the critical parameter (potential CAO or even RCAO).

In case that parameter β is a modifiable parameter, the operator can modify it so that the machine can operate normally again (resume normal operation).

Industrial machine 101 (and machine 102 if physical) operates according to the laws of physics, so that any deviation in the parameters (and in the representing variates) has a duration that is related to the machine components. To stay with the first example, an interruption of the power supply stops the heater, but it takes a certain interval until the temperature decrease of the water can be detected.

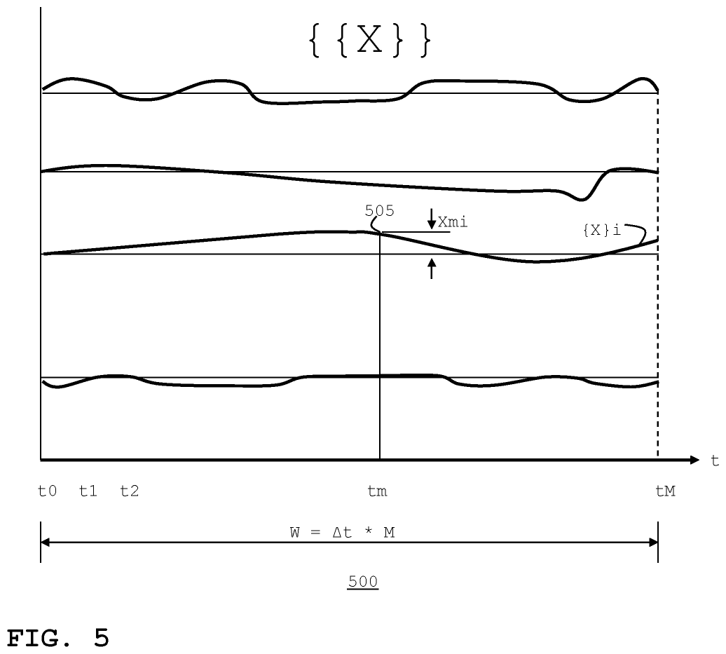

The computer therefore processes the parameters that take such intervals into account, the representing variates are collected for an appropriate time WINDOW (cf. FIGS. 4-5).

FIGS. 4 and 5 illustrate multi-variate time-series 500 that represent pluralities of machine parameters. The figures are equivalent and differ only in the way the parameter samples are illustrated. FIG. 4 shows discrete samples by dots, and FIG. 5 combines the dots to lines (as in FIG. 2).

{{X}} stands for a multi-variate time-series, with i=1 to N variates {X}i. Index i is the variate index, and N is the variate number. {{X}} comprises a plurality of single-variate time-series.

The variates {X}i are given in single-variate time-series. In alternative notation, the single-variate time-series can be given as a sequence of samples {X1 . . . . XM} i.

M is the number of samples in an observation interval WINDOW (i.e., the temporal length of the time-series), and individual samples are identified by index m. The interval has a duration of WINDOW=Δt*M. Δt stands for the sampling interval. As used herein, Δt is the same for all i. This is convenient for illustration, but not required in reality. Different single-variate time-series can use different sampling intervals. For example, a temperature would be measured every minute, Δt=60 seconds, but a current would be measured every second, Δt=1 second.

As mentioned, the duration of WINDOW takes delays into account (such as measurement delays caused be the intrinsic properties of the machine's components).

The notation Xmi stands for the numerical value of parameter sample 505 at time point tm in variate {X}i. For example, Xmi could be temperature value 30° C. As the semantics do not matter, it is possible to normalize the values. For example, for a temperature range from −30° C. to 70° C. (from “0” to “1”), the 30° C. could be processed as “0.5”. The figure illustrates variate ranges by arrows 510 (i.e., y-axes for each variate). The skilled person can apply pre-processing to filter out variate values that are not feasible. For example, a defective sensor may occasionally output a value for 1 000° C. so that such excess values can be neglected.

Time points tm are given for the end of each sampling interval Δt. This is just a convenient convention, in other words, tm identifies the sampling interval that ends at tm.

As used herein, a time-series represents the observation interval completely, from t1 to tM. Divisions in time are called “segments” (details explained for FIGS. 7 and 8).

In terms of the differentiation into modifiable parameters (index j in FIG. 2) and non-modifiable parameters (index k in FIG. 2), either index j or index k applies.

As the description differentiates between multi-variate and single-variate time-series by writing {{ }} or { }, the description occasionally omits “multi/single-variate” or places them in parenthesis, respectively.

### Other Time-Series

The description refers to time-series in that parameter samples 505 have numerical values. With or without normalization, the skilled person can code Xmi with appropriate data formats (such as real numbers in floating point numbers; integers etc.). As some the parameters would usually be represented by binary data (TRUE/FALSE, ON/OFF etc.) or even by text or strings, the skilled person can apply the method to such variates.

### Time-Series for Different Machine Roles

FIG. 6 illustrates the conceptual difference between time-series that are related to different machine roles (101, 102 in FIGS. 1-2).

Operational (multi-variate) time-series 501—also noted as “first series” or {{X}}_op-represents the operation of industrial machine 101. The figure uses bold line notation.

Reference (multi-variate) time-series 502—also noted as “second series” or {{X}}_rf)—represents the operation of reference industrial machine 102 (as implemented by any of the above-mentioned implementation scenarios, 1st to 5th). The figure uses dashed line notation.

Both multi-variate time-series 501 and 502 are corresponding in that reference series 502 has samples that correspond to samples in operational time-series 501 ({{X}}_op corresponds to {{X}}_rf).

Variate correspondence 513 (illustrated by different line styles bold and dashed, cf. the legend) means that a single-variate time-series {X}i_op has an equivalent single-variate time-series {X}i_rf, because both series refer to the same type of parameter. The skilled person can identify corresponding time-series in advance, the description uses the same index i. In the above example, parameter P3 (the temperature) has corresponding time-series {X}3_op and {X}3_rf.

For simplicity it can also be assumed that the number of variates N is the same in both {{X}}_op and {{X}}_rf. This is convenient, but not required.

Time correspondence 514 (illustrated by a vertical line) means that for two single-variate time-series {X}i_op, and {X}i_rf, there are samples that are taken at the same relative time (here at t10).

The skilled person is able to normalize the time. As the reference time-series is usually taken prior to the operational time-series, absolute calendar time points (in YYYYMMDDHHMMSS) can be re-calculated to relative time points (e.g., to the start of the observation WINDOW, at t0). For example, {{X}}_op starts at 20220222220000, and {{X}}_op starts at 20220122220000 (one month earlier, at 10 pm), and t10 occurs 10 minutes later. The relative time point t10 would be HHMMSS=001000.

Variate correspondence 513 and time correspondence 514 does not mean that all samples would be equal. The figure illustrates that by different magnitudes of the lines.

In the above example, {X}1 may have values within a certain tolerance band, {X}2 would be ON all the time (in normal operation from t0 to tM), and {X}3 would be rising.

The correspondence is directed, from first series 501 to second series 502 (i.e., from operational to reference).

It is possible that correspondences are missing. The reference series 502 may have variates (e.g., variate 512) that are not available in series 501 {{X}}_op. For example, reference machine 102 measures the temperature at more points than machine 101 does. Or, series 501 may have variates (e.g., variate 511) that have no reference.

The skilled person can define time correspondence 514 otherwise, for example, to define an OFF-ON switch of a machine component as a corresponding time point no matter of the relative time lapsed since t0.

It is noted that the skilled person can obtain reference multi-variate time-series 502 (i.e., the reference) by approaches, among them the following:
The computer (not necessarily computer 200) can process a collection of historical operational multi-variate time-series {{X}}_op and can apply statistical metrics. For example, the metrics can identify (a) minimal and maximal value (for Xmi), separated for m, (b) average values (for Xmi), (c) median values (for Xmi), (d) lower and upper confidence values (e.g., by taking the statistical standard deviation into account).
The computer can use a trained auto-encoder (cf. module 215 in FIG. 1, details below in connection with FIG. 13). The auto-encoder reestablishes {{X}}_op but would neglect deviations.

The approaches to obtain reference multi-variate time-series 502 are applicable to the implementation scenarios for machine 102 that has been introduced above (1st to 5th).

The description has already started to discuss deviations. As some deviating segments are to be replaced by normal (reference) segments, the description discusses segments with more detail. The description will also refer to the error function L(v).

### Further Theoretical Example

The description continues with a further theoretical example, this time with deviating parameters (and representing variates) identified by the Greek letters λ, μ and ρ.

### Deviations

FIG. 7 illustrates multi-variate time-series 501, {{X}}_op with a deviation in one of the single-variate time-series {X}λ.

As used herein, a single-variate time-series {X}i is a deviating single-variate time-series if it comprises at least one “deviating segment” /X/i (i.e., segment in which samples deviate from corresponding samples of the reference time-series 502). In other words, the property “deviating” applies to a time-series if at least one segments deviates. In other words, a single-variate time-series can “inherit” the attribute “deviating” from one of its segments.

The computer establishes deviation by applying pre-defined rules (that are set by the skilled person). One option is to the use the above-mentioned expectation reference (e.g., {{X}}_rf in that function.

To put it simply, the rules can be oriented to curve discussions that are well known, and the skilled person can used further rules. For example, /X/λ looks like a U-shaped line and the skilled person can detect such or similar patterns as deviations. Or, the sequences usually follow a standard shape, but occasionally, the curves turn off-shape.

The figure illustrates single-variate time-series {X}1, {X}2 and {X} N as non-deviating, and illustrates {X}λ as deviating.

The deviating segment is limited to the time interval starting at tSλ and ending at tEλ. Index S (“start”) stands for the first sampling time tS and index E (“end”) stands for the last sampling time tE of that segment. As used herein, the limiting samples belong to the segment. This is a mere convention, the skilled person can define the segments as an open interval as well.

In order to keep the mathematics as simple as possible, the description writes !X! for any (single-variate) segment (in a deviating time-series) that does NOT show a deviation (optionally with index i). In the example, there are two such segments (before tS and after tE). The !! notation can be applied to the non-deviating single-variate time-series {X}1, {X}2 and {X} N as well.

In other words, the notation { } indicates time-series, the notation !! indicates a non-deviating segment within the time-series, wherein the non-deviating segment can be the same as the time-series (i.e., in case of non-deviating time-series).

A deviation of a single variate may be related to an abnormal operation of the machine, or not.

In the above first example, the temperature decrease (detected by the computer that identifies a deviation in the thermometer reading) may be an indicator of the abnormality but may not be its cause. Assuming that the temperature develops as usual (i.e., without deviation to the reference), the computer can calculate a performance indicator for the machine with a corrected variate.

As mentioned, the computer does not apply semantics, the deviating time-series would just have samples with numbers (cf. 0.5 instead of 30° C.).

### Pseudo-Correction by Replacement

FIG. 7 also illustrates correction samples (taken from the reference, illustrated by dotted line) in a corresponding segment from the reference time-series (in the function to be the replacement reference). As used herein, the correspondence to the reference time-series 502 (FIG. 6) is established by applying tS and tE to the single-variate time-series {X}λ_rf with the same variate A.

In other words, the computer corrects a deviating (single-variate) time-series (such as {X}λ)
by keeping the one or more non-deviating segments (e.g., !X!\ before tSλ and !X!\ after tEλ), and
by replacing the one or more deviating segments (e.g., /X/A) by corresponding
replacement segments from a reference time-series (e.g., {X}λ_rf).

In other words, the computer concatenates segments:

{X}λ_cv=!X!λo^{˜}X^{˜}λo !X!λ. The symbol “o” stands for the concatenation, and the index v identifies the variation (cf. FIG. 11, v=1 and v=3).

The multi-variate time-series {{X}}_op is corrected to {{X}}_cv (cf. numeral 503 for plain lines in combination with dotted lines, or for plain lines only). (The acronym “cv” can be considered as a short version of “co_v” that is corrected for variation v).

The correction is introduced here as a tool to estimate a would-be-development of the deviating time-series {X} A.

As used herein, the correction can be a “zero-correction” for non-deviating time-series. As there is no deviating segment //, the “corrected” time-series would correspond to its original, or {X}_cv=! X!

FIG. 7 illustrates such non-deviating time-series for {X}1_cv=! X!1, {X}2_cv=! X!2, and for {X} N_cv=!X!N. (Index v would apply to v=1 to v=V).

Since the industrial machine has multiple parameters, the description now looks at this aspect.

### Multiple Deviations as Candidates for Replacement

FIG. 8 illustrates the multi-variate time-series of FIG. 7 with a further deviation segment /X/μ, in variate {X}μ.

The above notation applies for
{X}λ_cv=!λ!λo^{˜}X^{˜}λo!X!λ.
{X}μ_cv=!X!μo^{˜}X^{˜}μ!X!μ.

The multi-variate time-series {{X}}_op is corrected to {{X}}_cv. In view of FIG. 11, index v would be v=3 because the replacement is applied to both λ and μ. For different variations, the concatenations o are applied otherwise (other replacements, v=1, 2, 4).

In the example, the replacements in the single-variate time-series apply to the multi-variate time-series.
{{X}}_cv={{X}1_cv}, {X}2_cv, {X}λ_cv, {X}μ}} (cf. v=3, in FIG. 11)
{{X}}_cv={{X}1}, {X}2}, {X}λ_cv, {X} μ}} (equivalent notation, because variates 1 and 2 are not changed)

In this simplified illustration, the deviation segment /X/λ or the deviation segment /X/μ could lead to the identification of λ being the critical parameter.

### Multiple Deviations Distributed Across the Same Single-Variate Time-Series

Deviating segments do not have to be distributed across different time-series in different variates (here {X}) and {X}μ). One and the same variate (such as {X}ρ may show two (or more) deviating segments (e.g., non-deviating segment !!, deviating segment //, non-deviating segment !!, deviating segment //, and so on).

By way of examples, FIG. 8 also illustrates further deviation segments /X/ρ1, /X/ρ2, and /X/ρ3, in variate {X}ρ that can be replaced by segments ^{˜}X^{˜}ρ1, ^{˜}X^{˜}ρ2, and ^{˜}X^{˜}ρ3, respectively, from the replacement reference (i.e., from the {X}ρ in {{X}}_rf). The indices 1, 2 and 3 can be regarded as a position index, within {X}ρ.

The computer will process a corrected multi-variate time series {{X}}_cv together with reference multi-variate time series {{X}}_rf and with operational multi-variate time series {{X}}_op to determine the error value (error function L(v), FIG. 10).

But before going into details for that, the description notes that replacements do not have to be applied for all possible options. The computer rather varies potential replacements. For example, there is a set of 4 replacement variations: v=1: to replace /X/λ only, v=2: to replace /X/μ, v=3: to replace both /X/λ and /X/μ, or v=4: to replace nothing.

There are 8 further variations for {X}ρ, to replace /X/ρ1 only, to replace /X/ρ2 only, to replace /X/ρ3 only, to replace /X/ρ1 and /X/ρ2, to replace /X/ρ2 and /X/ρ3, to replace /X/ρ1 and /X/ρ3, to replace /X/ρ1, /X/ρ2, and X/ρ3, or to keep any/X/ρ unchanged.

In total (for λ, μ, φ there would be V=32 variations.

For each of the variations, the differences between _cv and _rf (if quantified) would be different (cf. L(v) in FIG. 10).

### Finding the Critical Parameter

In view of the goal to find the critical parameter(s), there are two aspects to consider. The aspects are interrelated but they are also conflicting. The computer can identify a particular replacement variation for that the difference between time-series with replacements to time-series without replacement can be minimized. However, such a replacement variation might not point to the critical parameter.

In the first aspect, the computer calculates a first term (571 in FIG. 10) that represents the differences between
the corrected (multi-variate) time-series {{X}}_cv (for a particular variation v), and
the reference (multi-variate) time-series {{X}}_rf.

In view of the figures, the first term corresponds to the area between the bold lines and the dotted lines. Some variations correct more segments, some variations correct less segments. To put it simply, there would be one variation for that the first term would be minimal. But that variation would have relatively many corrections and these many corrections would not indicate the critical parameter. On the other hand, relatively large areas are potentially associated with the critical parameter CP. For example, in FIG. 8, the area for /X/λ and its replacement ^{˜}X^{˜}λ is larger than the area for /X/μ and its replacement ^{˜}X^{˜}μ.

In the second aspect, the computer takes the number of replacements into account as well.

The second term (i.e., 572 in FIG. 10) represents the differences between
the corrected (multi-variate) time-series {{X}}_cv (for a particular variation v), and
the operational (multi-variate) time-series {{X}}_op (i.e., the original).

For example, replacing the first, second and third deviating segments in {X}ρ leads to a relatively small overall area (first aspect), but that distracts from the critical parameters.

Both aspects (i.e., both terms) are interrelated, in the following:
The (variation specific) error function L(v) is the sum of two error components: L(v)=C1(v)+C2(v), cf. error components 551 and 551 in FIG. 10.
Both components C1(v) and C2(v) comprise weighting factors f1 and f2 that are independent from the variates (and that are independent from the replacement variations).
In implementations, both components C1(v) and C2(v) can comprise terms 571 and 572, with non-linear emphasis: the first term 571 emphasizes the differences by squaring them², and the second term 572 keeps the differences by merely processing their absolute values | . . . |.

In that sense, the error function is sensitive (to replacements that correct deviations, first term) but also to the number of replacements (second term). In other words, making replacements is a suitable approach to find the critical parameter CP, but applying too much replacements would broaden the number of potential CPs. The factors f1 and f2 fine-tune the sensitivity. The calculation of error function L(v) is therefore a compromise.

In other words, while C1 reduces to the error value for segments that are relatively “far off” from the reference (i.e., by the amount of their deviation), C2 increases the error value by the number of replacements. C1 and C2 act like “reward” and “punishment”, respectively.

The description will explain the details for calculating the error value (according to the error function L(v)) in connection with FIGS. 9 and 10. Thereby, the description stays with the λ and μ examples. The skilled person can take ρ (and any further deviating series) into account.

FIG. 9 illustrates corrected single-variate time-series {X}λ_cv and {X}μ_cv. Similar as for line 503 in FIGS. 7-8, bold lines for the original (“op”) are concatenated with dotted lines for the replacement (“rf”).

The figure also illustrates the variate-corresponding single-variate time-series {X}λ_rf and {X}μ_rf of the replacement reference (dashed lines). The time-series belong to the multi-variate time-series, the non-deviating time-series are not illustrated (cf. FIGS. 7-8). The example of FIG. 9 corresponds to replacement variation having index v=3 of FIG. 11 (replacements in /X/λ and in /X/μ).

In view of C1 (first aspect), the figure also illustrates the correction-reference-difference ΔXmi_cv_rf that—for any given point in time tm—is the difference between
the sample value Xmi_cv (of the corrected time-series, bold or dotted line) and
the sample value Xmi_rf (of the reference time-series, dashed line).

For simplicity, the figure only illustrates ΔXmi_cv_rf for the deviating time-series {X}λ and {X}μ, but the general definition is the following:

$$ΔXmi\_cv \_rf = Xmi\_cv - Xmi\_rf .$$

ΔXmi_cv_rf can be (substantially) zero when {X}i_op follows {X}i_rf for some time points. In theory, ΔXmi_cv_rf is zero for segments that have been replaced (if ^{˜˜} is taken from the reference).

### Squared Difference

In an implementation example, a metrics that indicates the distances between the corrected time-series {X}i_cv and the reference time-series {X}i_rf can be given by summing up ΔXmi_cv_rf*ΔXmi_cv_rf from t1 to tM, i.e., from m=1 to m=M. The sum SDV(i) (squared difference for the variate) is calculated as:

SDV(i)=Σ(ΔXmi_cv_rf)² (for m=1to m=M).

As the distances in the graphs correspond to differences in values, SDV(i) can be regarded as a “value difference”.

The SDV(i) (for the individual variates i) can be summed up across the variates, to obtain a SDS (squared difference for the multi-variate time-series).

SDS=>ΣSDV(i) (for i=1 to i=N).

In view of the overall goal to detect the cause of an abnormality (in the operation of machine 101), correcting all variates (to would-be-normal) may not lead to the identification of the CAO parameter.

The metrics can be part of the error function (in C1(v)), and variate-specific weights can be considered, cf. FIG. 10. FIG. 10 shows variate-specific weights “wi” in both terms 571 and 572.

Optionally, the first and second error components 551, 552 can each further comprise variate-specific weight factors wi. A first group of variate-specific weight factors wi (if index i corresponds to index j, cf. FIG. 2) can be specific to the variates that represent modifiable parameters, and a second group of weight factors wi (i corresponding to k, cf. FIG. 2) that are specific to variates that represent non-modifiable parameters. All weights of the first group may be different (in terms for “greater than” or “smaller than”) than all weights in the second group.

Since the operator might rather modify modifiable parameters, there is an assumption that modifiable parameters contribute to abnormal operation more than non-modifiable parameters. The weights are selected accordingly: the weights in the first group can be larger than the weights in the second group.

### Linear Difference

Having explained the squared difference, the description shortly returns to FIGS. 7-8. Likewise, the differences can be calculated between the samples of the corrected time-series, and the operational time-series: ΔXmi_cv_op=Xmi_cv-Xmi_op. As the difference is part of the second term (i.e., 572 in FIG. 10) by its absolute value, the mathematical order does not matter.

### Further View

As component C1 (v) focuses on the values (cf. the squaring), it can be considered to be a “deviation value component”, and as component C2(v) focuses on the number of occurrences, it can be considered a “deviation number component”.

Replacement Variation that Points to CP

FIG. 11 illustrates replacement variations that the computer uses as a tool to identify a particular error value among a plurality of values. In the example, the computer applies the replacement scheme to consider all possible variations: to replace /X/λ only, replace /X/μ, replace both, or replace nothing.

The variations v are given together with the error values L(v). For convenience of explanation it can be assumed that L(1) is L_min, so that the variation v′=1 that merely replaces /X/λ only would lead to the smallest error (i.e., L(1)=C1(1)+C2(1)), cf. step 450 in FIG. 12.

For that determined variation (v′), the computer selects the one or more variates with the previously selected (441) one or more deviating segments (/X/λ, /X/μ) as one or more variates that represent one or more critical parameters (CP). In variation v=1, the computer has selected /X/λ for replacement, and therefore variate {X}λ represents the critical parameter CP.

As symbolized in FIG. 1 (user interface 290), the computer provides (step 460 in FIG. 12) an identification of the one or more critical parameter CP to operator 190 of industrial machine 101. In the example, the computer tells CP=λ. Operator 190 can now modify λ (if possible, otherwise modify the corresponding machine component).

So far, the description has used singular (the critical parameter CP), but multiple parameters (i.e., a subset of parameters from i=1 to N) can be identified as critical (to cause abnormal operation, or indicate parameters). For example, the two smallest L(v) with v′ and v″ point to two critical parameters.

Replacement Variation that Points to CP, Higher Accuracy

For the operator, the identification of CP=λ is convenient, and—optionally but in many scenarios—the computer lets the operator look at the data. In the example, the operator can see that parameter λ was deviating during tSλ and tEλ (cf. FIGS. 7-8).

It is however possible that the computer does not only select the variates with the previously selected 441 deviating segments (e.g., /X/λ), but that—in addition to that—the computer identifies the deviating segment (for example, by position index). The examples with deviations in λ and μ (FIG. 8) assumes a single deviation per time-series, the example with the deviation in ρ assumes multiple deviations per time-series (e.g., /X/ρ1, /X/ρ2, and /X/ρ3 in FIG. 8). Since replacement variations are also possible for such cases (cf. the above discussion with V=32 variations), it could be that L(v) is minimal for a particular selection in ρ. The computer would indicate the variate (representing parameter ρ as CP), and would also indicate the position.

### Method Flow-Chart

FIG. 12 illustrates a method flow-chart of computer-implemented method 400.

Method 400 is a computer-implemented method for differentiating parameters (cf. parameters as illustrated by their representation as line 501 in FIG. 6) of a particular industrial machine (cf. machine 101 in FIGS. 1-2).

The computer (such as computer 200 in FIG. 2) identifies a subset of parameters (as represented by variate subset, such as B in FIG. 3, or u in FIG. 8, 550) to be critical parameters (CP) that cause abnormal operation of the industrial machine (and/or that indicate one or more further parameters that cause abnormal operation).

The computer processes multi-variate time-series (as in FIGS. 5-6, 500, 501, 502 {X}i) that are pluralities of single-variate time-series that represent the parameters of the particular industrial machine.

In step receiving 410, the computer receives first multi-variate time-series {{X}} _op (such as series 501) that represents the operation of the particular industrial machine.

In step obtaining 420, the computer obtains second multi-variate time-series {X}}_rf (such as series 502) that has representative samples in correspondence to first multi-variate time-series {{X}}_op. The correspondence has two aspects: variate correspondence 513 (i_op corresponding to i_rf) and time correspondence 514 (tm corresponding, between t0 and tM). The computer can perform receiving 410 and obtaining 420 in any order, and the computer does not have to perform step 420 for each method execution instance.

In step identifying 430, the computer identifies—in the first multi-variate time series—at least two deviating segments (explained by example for /X/λ, /X/μ in FIGS. 7-8) in which samples deviate from expected values.

The computer then performs a number V of activities that apply activity-specific replacement variations v (cf. FIG. 11). The description calls them activities 440 and distinguishes them as steps 441, 442 and 443.

In step selecting 441, the computer selects one or more of the identified deviating segments (cf. /X/λ, /X/μ) according to a particular replacement variation v (cf. the example in FIG. 11).

In step replacing 442, the computer replaces the selected one or more deviating segments (/X/λ, /X/μ) by the corresponding one or more segments of the second multi-variate time-series (^{˜}X^{˜}λ, ^{˜}X^{˜}μ). The computer thereby obtains a corrected first multi-variate time-series ({{X}}_cv (cf. FIGS. 8-9).

In step determining 443, the computer determines error value L(v). The description has discussed the error value above with FIG. 10. L(v) is the sum of two error components C1(v) and C2(v), cf. 551 and 552 in FIG. 10.

The first error component C1(v) is related to the corrected first multi-variate time-series 503, {{X}}_cv and to the second multi-variate time-series 502, {{X}}_rf (cf. FIGS. 6-9). The second error component C2(v) is related to the corrected first multi-variate time-series 503, {{X}}_cv and to the first multi-variate time-series 501, {{x}}_op.

As a result of the activities, the computer has determined, for example, V error values L(v) for V variations.

In step determining 450, the computer determines the variation v′ for which the determined error value L(v) has its lowest value (or has a relatively low value, compared to others). As the computer has replaced deviating segments, there is a combination of deviating segments (i.e., in variation v) that have most contribution to the error.

For that determined variation v′, the computer select the one or more variates with the previously selected (step 441) one or more deviating segments /X/λ, /X/μ as one or more variates that represent one or more critical parameters CP. (In the example of FIG. 11, v′=1 because the error is L_min.) Also, in step providing 460, the computer provides an identification of the one or more critical parameter CP to operator 190 of the industrial machine 101.

### Further Method Details

As explained above with FIG. 10, the first error component C1(v), 551 can comprise the sum of the squared differences between the corrected first multi-variate time-series {{X}}_cv, 503 and the second multi-variate time-series {{X}}_rf, 502, and the second error component C2(v), 552 can comprise the absolute value of the linear difference between the corrected first multi-variate time-series {{X}}_cv, 503 and the first multi-variate time-series {{X}}_op, 501.

The first error component C1(v), 551 deserves further attention because it can be calculated otherwise. C1(v) can comprise the sum of the number of time-slots Δt for which the corrected first multi-variate time-series {{X}}_cv, 503 and the second multi-variate time-series {{X}}_rf, 502 are different. The notation “sum of number of time-slots” is a convenient synonym for “how long in total”. Since—depending on v—not all deviations are corrected, the corrected series {{X}}_cv will be different from {{X}}_rf. The calculation can use 2 from i=1 to N, in other words, the computer counts the slots for the differences for variate {X}1, for variate {X}2, and so on, and sums up the difference for all N.

FIGS. 7-8 can serve as an example. Variates {X}1 and the {X}2 do not show deviations, there are no slots with corrections. Variate {X}λ can have a correction (in v=1 and v=3, cf. FIG. 11) so the time-slots Δt are counted between tSλ and tEλ. Variate {X}λ does not have corrections in variations v=2 and v=4, so that no time-slots Δt would be counted. For variate {X}μ the same approach applies.

In an alternative, the first error component C1(v), 551 can comprise the number of corrections in the corrected first multi-variate time-series (503, {X} _cv). This approach is potentially easier to implement, because the start and end time-slots can be ignored. FIG. 8 can serve as an example as well. For an assumed correction in a variation that replaces, /X/λ, /X/μ and /X/ρ1, there are 3 replacements.

As already explained, FIG. 10, the first error component and the second error component can comprise first and second weight factors f1, f2, respectively.

As already, explained, the one or more critical parameters can be cause-of-abnormal-operation (CAO) parameters.

### Deviations

The computer can identify the segments with deviations in the first multi-variate time-series {{X}}_op (cf. step 430) by applying one or more pre-defined rules. Such rules can be selected from the following:

For example, the computer can-separately for each variate {X}i-compare the single-variate time-series of the first and second multi-variate time-series and identify deviating segments as segments in that corresponding samples (cf. time correspondence 514 in FIG. 6) have a value difference (Emi_op_rf in FIG. 6) above a pre-defined threshold.

For example, the computer can-separately for each variate {X}i-compare the single-variate time-series of the first and second multi-variate time-series and identify deviating segments as segments in which an integral (i.e., the integral of the difference) is above a pre-defined threshold integral. In graphical illustrations, the integrated difference between {X}i_op and {X}i_rf can be regarded as the area between both lines 501 and 502, cf. FIG. 6. For some variates-such as {X}λ in FIG. 7—the area exceeds a threshold value. Such curve discussions are known in the art so that further details are omitted.

For example, the computer can-separately for each variate {X}(i)—compare the single-variate time-series of the first and second multi-variate time-series and identify deviating segments according to the derivatives. FIG. 7 shows variate {X}λ with a relatively high derivation at tSλ and at tEλ (down and up).

Optionally, computer 200 can identify the deviating segments (in step 430, such as /X/λ, /X/μ) by processing the first multi-variate time-series 501 (“op”) by a pre-trained auto-encoder module that establishes a reconstruction of the first multi-variate time-series 501 so that the reconstruction of the first multi-variate time-series 501 takes over the function of the second multi-variate time-series 502 “rf”. Implementation details for the auto-encoder and for the reconstruction follow in connection with FIG. 13.

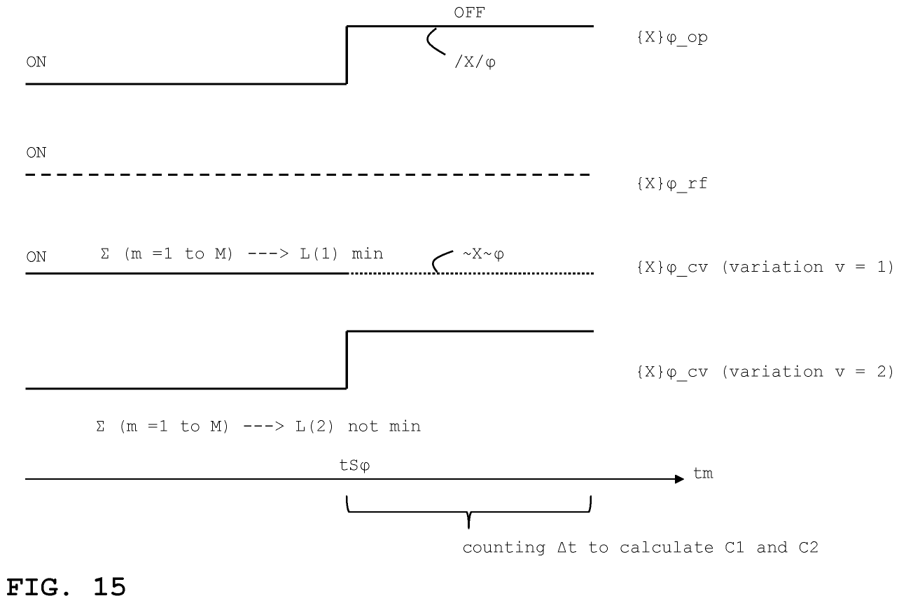

The skilled person can apply other approaches, a further example is related to a state (of a component) with FIG. 15.

### Still Further Details

The description introduces some further aspects for the method steps of FIG. 12 in this section, but introduces implementation details in the next sections, with FIG. 13.

The computer 200 can identify (step 430) the deviating segments by processing the first multi-variate time-series 501 by pre-trained auto-encoder module 215 (cf. FIGS. 1 and 13) that establishes a reconstruction of the first multi-variate time-series 501 so that the reconstruction of the first multi-variate time-series 501 takes over the function of the second multi-variate time-series 502.

For simplicity, the reconstruction will be called {{X}}_rf as well, and will be shown as lines 521 in FIG. 13.

### Auto-Encoder as Reference

FIG. 13 illustrates an auto-encoder module (cf. module 215 in FIG. 1) in combination with multi-variate time-series. The auto-encoder corresponds to the 4th implementation scenario for reference data already explained.

Auto-encoder 215 can be implemented by a neural network that has been trained with historical data, such as with historical time-series {{X}}_op from machine 101 (or even with {{X}}_rf, for example, from reference machine 102).

It is noted that auto-encoder 215 does not have to be trained with data that shows abnormalities (or that shows deviations). In other words, using an auto-encoder may be advantageous because it does not have to be trained with data that represent abnormal operation of the reference machine 102. There is also no need for annotations (such as to annotate deviations as such).

Auto-encoders are explained in scientific papers, such as in “Cyriana M. A. Roelofs, Marc-Alexander Lutz, Stefan Faulstich, Stephan Vogt: Autoencoder-based anomaly root cause analysis for wind turbines. Energy and AI 4 (2021) 100065”.

The auto-encoder can be a convolutional auto-encoder, or an LSTM auto-encoder, or any other structure that can process sequential data, with an example explained in “Roy Assaf, Ioana Giurgiu, Jonas Pfefferle, Serge Monney, Haris Pozidis and Anika Schumann ‘An Anomaly Detection and Explainability Framework using Convolutional Autoencoders for Data Storage Systems’, Proceedings of the Twenty-Ninth International Joint Conference on Artificial Intelligence (IJCAI-2000) Demonstrations Track”.

As illustrated in this much simplified example, FIG. 13 shows multi-variate time-series {{X}}_op with N=6 variates (cf. FIG. 6, lines 501 in bold, variate 1 to 6 are identified). The individual single-time series show the following remarkable points:
Case (1) in variate {X}1 shows a short-time drop below zero and a subsequent short-time rise above zero in {X}1, at the end of the WINDOW.
Case (2) in variate {X}2 shows a short-time rise above zero that stays at that level, starting approximately when the drop in {X}1 occurs.
Case (3) in variate {X}3 shows a U-shaped drop somewhere before mid-term in WINDOW (cf. FIG. 4).
Case (4) in variate {X}4 shows a series without particular observations, there are no deviations.
Case (5) in variate {X}5 shows a short time rise/drop at the end.
Case (6) in variate {X}6 shows a gradual decrease in the values, over time during WINDOW.

These cases (1) to (6) are explained here for convenience of illustration, and the computer would not describe them in words.

Auto-encoder 215 processes {{X}}_op and obtains processed time-series that can be regarded as reference {{X}}_rf, or as reconstruction 521, here noted by dashed lines (similar as line 502 in FIG. 6.). (There is a minor conceptual difference: the reconstruction can be used as reference in various functions: expectation reference, replacement reference, etc., but it does not have to be used as reference).

Since auto-encoder 215 reconstructs the series according to historic observations, it does not repeat some of the drops and rises in reconstruction 521. More in particular, in variate {X}1, the reference does not drop or rise but does not show case (1), variate {X}2 does not show the rise (2) either, variate {X}3 comes without the “U”, variate {X}4 is more or less is the same as the input at “_op”, variate {X}5 does not show the drop/rise in (5), and variate {X}6 shows the line without much slope (6).

As explained, the computer (i.e., with modules 221, 220, 230 and 240) performs method 400 (cf. FIG. 12) and eventually detects (1), (2), (3), (5) and (6) as deviating segments.

In variations, the computer determines errors (right side of the figure). (For simplicity, it can be assumed to have only V=6 variations (to correct in {X}1, in {X} 2, . . . in {X}6, no combinations as in FIG. 11). The errors have positive values: in case (1) the drop translates to a rise, the rise stays a rise; in case (3), the U turns to an “Omega” and so on. However, the difference between the decreasing line (in op, on the left) and the relatively stable line (in rf, on the right side) would have the largest impact. By applying the correction as explained above (cf. replacing in step 442, FIG. 12), L(v) would be minimized for that variation.

As a consequence, the computer would provide the parameter in case (6) as the critical parameter CP to the operator.

### Updating the References

FIG. 14 illustrates the method flow-chart of computer-implemented method 401 with an optional approach to update references. So far, the description has explained method 400 in the context of replacement variations (index v, 440 in FIG. 12).

In addition to that, the accuracy finding the critical parameter CP can be enhanced by additionally modifying the reference {{X}}_rf in variations. For convenience, the description uses the term “updating the reference” and identifies reference updates by index “u”. The number of updates is limited by the opportunities to modify the reference, identified here by uppercase “U”.

Once an initial {{X}}_rf has been used (steps 441, 442, 443, cf. FIG. 12) to determine L(v) for V variations, the steps can be repeated by with an updated reference, for example along the 1st to 5th implementation scenarios explained above.

To name only some examples, {{X}}_rf can be taken from different times (1st, physically the same machine), from a physically difference reference machine 102 (2nd), from a different reference virtualization (3rd).

According to the 4th scenario, the autoencoder can—in the repetitions—process corrected time-series (such as {{X}}_cv, instead of {{X}}_op) to update reference updates.

The computer that executes method 401 (FIG. 14) can apply the steps of method 400 (FIG. 12, i.e., steps 410, 420, 430, 440 with 441/442/443, 450 and 460) with a reference update in the following:
Step 420 is performed (in FIG. 14 as step 421) with an initial reference {{X}}_rf.
Step 443 leads to L(v, u) and not only to L(v).
Step 450 determines v from a larger step of error values L(v, u), in theory up to X*U values and not only V values as in FIG. 12.

The flow-chart symbolizes the update with a loop (“next u”, to be performed for U updates.), the skilled person can implement the update otherwise (such as by updating and processing in parallel).

Additionally, method 401 comprises step updating reference 422 (that replaces step 421 in repetitions).

FIG. 14 also illustrates optional step 415 “auto-encoding” as a step to identify the next reference update.

### Data in Alternative Format

FIG. 15 illustrates time-series for calculating the error function L(v) in a scenario with binary data. It does not matter if the computer applies method 400 (FIG. 12) with the optional reference update (401, FIG. 14) or not. Both approaches determine L(v), cf. step 443.

The error-function L(v)=C1(v)+C2(v) has been explained for scenarios in that the error components comprise differences between time-series (cf. the squared and the linear differences, with details in FIG. 10). Instead of differences between numeric value (real numbers, ΔXmi in terms 571, 582, FIG. 10), the L(v) function can be adapted, at least for some variates. In the first machine example, the circuit breaker (parameter φ) would go from ON to OFF at time point tSφ (there is no tE, it stays OFF).

As the 2-parts from m=1 to M of terms 571 and 572 summarize over time, the terms would be related to the duration of time. In other words, ΔXmi would be binary (e.g., zero or not zero) so that summing would correspond to just counting the number of Δt for that ΔXmi is not zero.

In the example of FIG. 13, the computer would identify /X/φ is a deviation (reference {X}φ_rf ON for all time), and would correct to ON all the time ({X}φ_cv for v=1) and correct to ON/OFF ({X}φ_cv for v=2).

The figure is simplified by not showing the other parameters (such as temperature decreasing etc., for that variations would be applied as well.

Assuming that the error function L(v)) would be minimal for v=1 and maximal for v=2 (taking the temperature parameter into account as well), the computer would identify the parameter φ as critical parameter, again not applying any semantics.

The figure illustrates the determination of L(v) by referring to C1 and C2 and Δt to be counted.

The ON/OFF change for parameter φ serves as example, the skilled person can use that parameter as a derivative (e.g., first transition if a numerical value exceeds a threshold, second transition, cf. the above description).

In other words, computer 200 can determine the sum of the number of time-slots Δt for single-variates time-series in that the values are binary (as illustrated by way of example for variate {X}φ).

In a non-limiting embodiment, the time-slots Δt can be counted (i.e., making the sum) for the time-slots corresponding to the corrections that had been applied by replacing (442) binary values. In other words, replacing i step 442 (cf. FIGS. 12, 14) simply means that the first binary value in /X/φ (e.g., OFF) is flipped to the second binary value in ^{˜}X^{˜}φ (e.g., ON instead of OFF, as illustrated by the dotted line).

In summary, a computing-resource saving approach is available for binary variates, such as {X}φ, by optionally replacing // to ^{˜˜} by simply changing the binary value (e.g., OFF to ON, ON to OFF, 1 to 0, 0 to 1) and by optionally counting the replacements per time-slots.

### Discussion

As explained, computer 200 presents the subset with the one or more critical parameters (CP) to operator 190. In case that the critical parameters are modifiable parameters (cf. FIG. 2, with index j), computer 200 could provide a control signal (or the like) to automate the modification. The skilled person can apply such control loop scenarios in case that automatic modification is feasible. (In the first fictitious machine example, automatically turning the breaker ON is not contemplated, for safety reasons).

The description has described variations (v, for replacements) and optional reference updates (u) for numbers V and U, respectively. Such an approach could potentially cause the computer to continue the performance of methods 400/401 for a relatively long time until the CP are provided in the last step (460). To explain this by the worst case scenario, the machine would start burning in one component and the computer would identify that component as critical. However, the computer would be late because the fire would have destroyed the machine in the meantime.

The skilled person can reduce the number of activities 440 (select 441, replace 442, determine 443), for example, by selecting the next variation to apply according to gradient descent (or similar approaches), by disregarding certain possible variations, by performing variations in a random sequence, by applying iterations, and so on.

From a general view point, the industrial machine can be a machine that performs an industrial process. For example, the machine can be a chemical reactor, a metallurgical furnace, a vessel, an engine. More specifically, in view of the operating principle, the furnace can be a blast furnace. To put it simply, the blast furnace receives ores and coke, as well as hot air (via tuyeres) and provides molten metal. It is well-established practice for such machines to collect operational data for hundreds of parameters or even more. Multi-variate time-series-such as {{X}}_op and {{X}}_rf are therefore available.

### Variate Pre-Processing

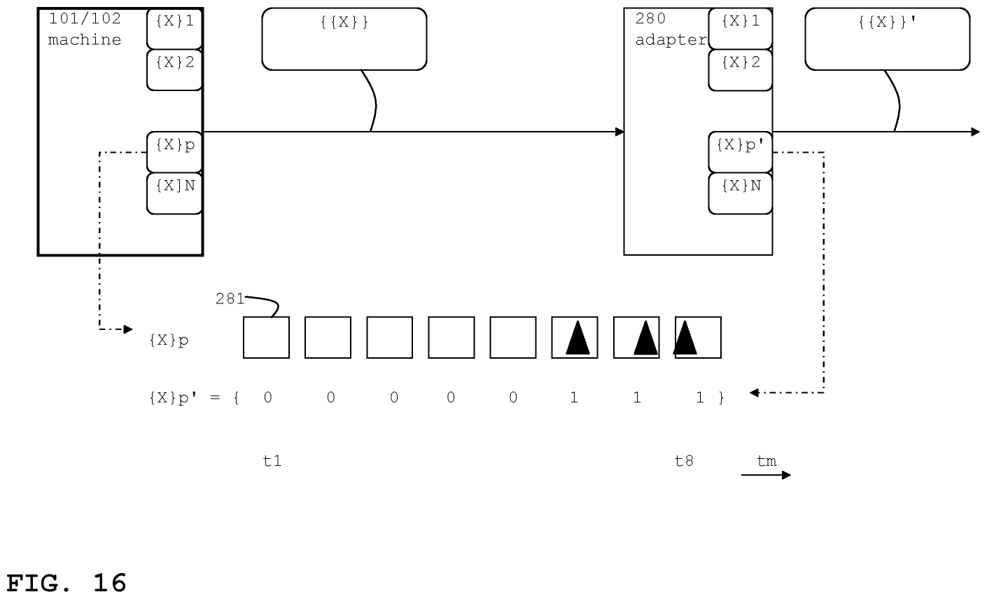

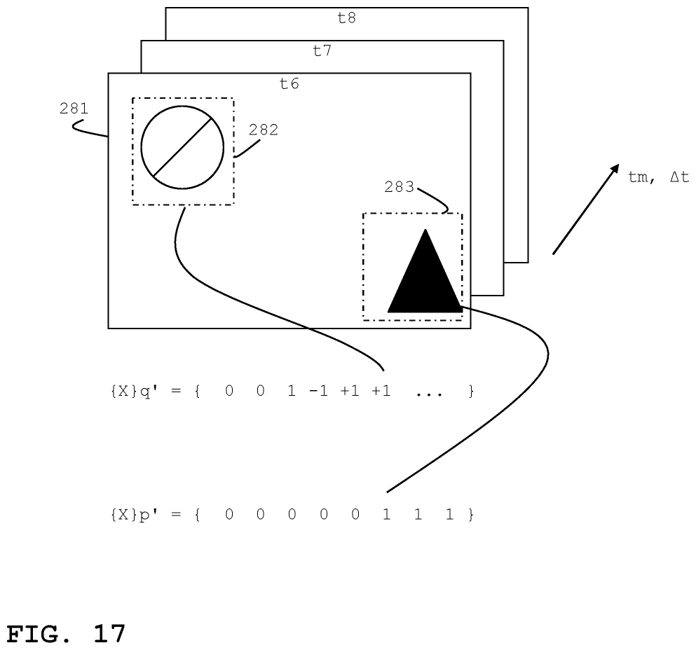

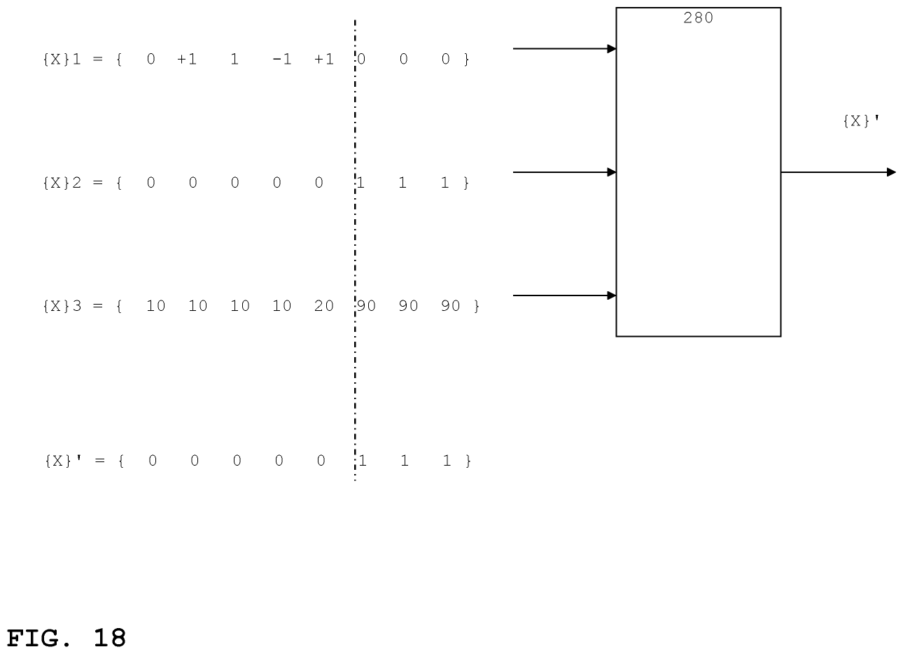

FIGS. 16-18 illustrate variate pre-processing. More in detail, FIG. 16 shows adapter 280 with image data to be adapted, FIG. 17 shows image data being adapted, and FIG. 18 shows data aggregation by adapter 280.

Adapter 280 can be implemented as part of the module that performs the receiving and the obtaining steps (cf. module 210 in FIG. 1, steps 410, 420 in FIGS. 12-14). By way of example, FIG. 16 illustrates adapter 280 for pre-processing data from industrial machine 101 (or from machine 102). Adapter 280 receives (one or more) multi-variate measurement time-series from industrial machine 101 or from reference machine 102 (as “op” and /or as “rf”). The figure is simplified by letting all N variates go through the adapter, but in implementations, not all variates need to be adapted.

As noted above, the notation Xmi stands for the numerical value of parameter sample 505 at time point tm in variate {X}i. FIGS. FIGS. 4-5 illustrate parameter samples 505 as scalars. The skilled person can receive (or obtain) the samples by well-known approaches, such as by collecting measurement data (as explained by the thermometer example), by collecting meta-data (from shop-floor applications, etc.)

However, data capturing is not limited to scalars. It is possible to apply data pre-processing that adapts the data modality, for example, from image data to scalar data, from sound data to scalar data, from vector data to scalar data, etc.

In other words, adapter 280 can optionally implement a modality adaptation of data that is originally available as non-scalar data. By way of example, this adaptation is shown for variate {X}p.

Data for variate {X}ρ could be a collection of digital images 281 (i.e., matrices with pixels that indicate colors). The images could be taken by a camera or by a scanner. Images 281 can be available as a sequence of images (e.g., for images every Δt, in the figure from t1 to t8).

Adapter 280 can process the images and can assign them scalar values here shown as time-series {X}p′. The dash ′ merely indicates that the assignment took place. The skilled person can apply image processing techniques such as classification, by a pre-trained neural network or otherwise.

For example, the images can show movable machine components and adapter 280 can classify the components as “moving” or “not moving” (binary classification), as moving at speed “0”, “1”, “2”, “3” etc. (being values for speed from stand-still to high speed rotation). Moving can be differentiated, for example, into translatory motion and rotation, and adapter 280 can identify attributes (by classification or otherwise) to distinguish, for example, movement “up” or “down”, to distinguish rotation in “positive” or “negative” direction senses, or otherwise. The attributes would correspond to the assigned numerical values.

In a further example, images 281 can correspond to one or more parameter that are visible (at least to “machine eyes”), such a surface temperature (usually by IR imaging), surface reflection, surface color, the presence or absence of typical topics on images, and so on.

For the above-mentioned blast furnace, a camera could take pictures of the tuyeres. As fires occur during the operation regularly, the images can be classified accordingly. Much simplified, an image showing fire can be coded to 1 (“fire is present”), and an image without fire could be coded to 0 (“fire is absent”). FIG. 16 shows the fire quite symbolically by triangles. The resulting single-variate time-series could be {X}p′ with parameters samples {0, 0, 0, 0, 0, 1, 1, 1}′, cf. 505, as “op”, and the computer would perform method 400 (or 401) as described, with {X}p′. Assuming that the reference would be {X}p′_rf with parameter samples {1, 1, 1, 1, 0, 0, 0, 0}, a deviation could be determined as unexpected “no fire” at the beginning and unexpected “fire” at the end of the WINDOW.

The skilled person can adapt sampling rates if needed. For example, image data may arrive as a video stream (with 25 image frames per second), and some frames may be removed to arrive at Δt (that may be much longer than 1/25 second).

In a further scenario (not illustrated by the drawings, but easily to imagine), the non-scalar elements could be sound sequences. For example, {X}p can be a collection of audio records (for example, each having a duration of Δt or less) from a microphone sensor. The person skilled in the art can apply appropriate sound processing, for example, by sampling the sound at a frequency of 20 kHz, leading to 60*20,000 audio samples per minute.

In the context of providing time-series with Δt spacing, adapter 280 would then process these millions of samples to single scalars. For example, the scalar could indicate: pitch rising during Δt, pitch falling Δt, pitch constant during Δt, pitch rising and falling during Δt and so on. Such patterns could be assigned to integers, or the varying pitch itself can be assigned to parameter samples 505.

FIG. 17 shows image data being adapted as shown in FIG. 16, but with a modification. Here, adapter 280 also receives an image sequence (shown for times tm=t6, t7 and t8) but assigns scalar values in two or more (single-variate) time-series, here given as {X}p′ and {X}q′ (the dash ′ again standing for the assignments). Adapter 280 identifies areas 282, 283 within images 281, and processes the data for the areas separately. In the example, area 282 shows a machine component (circle symbol in the drawing) that rotates in direction sense “+1”, or rotates in direction sense “−1”, or does not rotate at all “0”, as illustrated for the assignments in {X}p′. Area 283 shows a “fire” corresponding to “1” or shows “no fire” at “0”. In the example, the figure shows image 281 at time t6 (rotation in “+1”, fire is present).

Processing data according to method 400/401 requires computation resources (such as CPU, memory etc.) and the overall time obtain CR (cf. FIG. 1) may be critical (cf. the real-time requirement mentioned above.) The examples of FIGS. 16-17 show that pre-processing (with assigning non-scalar data to scalar data) may save resource consumption.

FIG. 18 shows data aggregation, and the applying such aggregation may also contribute to resource saving. As explained above (FIGS. 4-5), multi-variate time-series {{X}} are sets of single-variate time-series {X}i. It is possible to identify sub-sets (of single-variate time-series) and aggregate them before method 400/401 is being executed. For executing the method, the computer can use aggregated times-series, at least partially.

The figure shows an example, wherein three single-variate time-series {X}1, {X2}, {X3} belong to {{X}}. They are aggregated to single-variate time-series {X}′. {X}′ would then be part of multi-variate time-series for that method 400/401 is performed (as “op” or as “rf”).

In the example, {X}1 would indicate rotation of a machine component (with, or without applying the adaption of FIGS. 16-18), {X}2 would indicate a particular sound (cf. sound processing as mentioned), and {X}3 would indicate a temperature.

Just to illustrate this by an example, a motor being forced to stop makes some characteristic noise and heats up. A domain expert can define an appropriate rule so that {X}′ would change (e.g., from 0 to 1, from t6), for example: RULE: IF X1=0 (no rotation) AND X2=1 (sound) AND X3>80 THEN X′=1, ELSE X′=0. The rule is noted here without the { } because it would usually be applied at substantially all time points tm.

However, there is no need to apply such semantics, a further rule could indicate: raise an alarm if any sub-set of variates comprises a parameter that becomes a critical parameter CR (critical within that sub-set not for all N variate), by executing method 400/401. RULE: IF ANY OF Xi POINTS TO CR THEN X′=1, ELSE X′=0. Raising an alarm may not be required, the computer may start to investigate the details (by performing the method again, etc.). In FIG. 18, the vertical dash-dot line indicates that the aggregated scalar changes its value. In the example, the value is implemented in binary fashion, and simplifying the method for binary data (cf. FIG. 15) is possible.

An autoencoder (cf. 215 in FIG. 13) can be applied here as well, it may generate a numeric value that can be processed further (by the method). In other words, the subset of single-variate time-series at the input of an autoencoder let the encoder provide one or more time-series to become the input to method 400/401.

Further, data aggregation (i.e., a complexity reduction from N to 1, N to 2, N to “small number” is explained in papers such as
Zhihua Zhang, Michael I. Jordan, “Latent Variable Models for Dimensionality Reduction”, Proceedings of the Twelfth International Conference on Artificial Intelligence and Statistics, PMLR 5:655-662, 2009; and
W. Wang, Y. Huang, Y. Wang and L. Wang, “Generalized Autoencoder: A Neural Network Framework for Dimensionality Reduction,” 2014 IEEE Conference on Computer Vision and Pattern Recognition Workshops, 2014, pp. 496-503.

For scenarios introduced in FIGS. 16-18, adapter 280 can be implemented by a neural network that has been trained before, potentially under supervision (by human experts). For example, adapter 280 could have been trained with annotated images showing fire (in the blast furnaces), annotated sound sequences (taken from blast furnaces) and so on. Adapter 280 can also be trained in an unsupervised manner in order to identify an abstract representation of the image. That ensures the maximization of the informative content of the image. A sequence of images (or sounds) can then be reduced by this process to sequences of scalars.

To identify areas within images (cf. FIG. 17), the skilled person can apply techniques from autonomous driving (e.g., the car computer differentiates traffic signs from pedestrians). Statistics may play a role in training the network, in applying rules and so on.

Similar expert involvement can be applied to the selection of the sub-set to be aggregated (cf. FIG. 18). Selecting sub-sets (of time-series) virtually divides the industrial machine into groups, and the selection can take the components (cf. 110, 120, 130) into account.

Single-variate time-series that the adapter provides (such as {X}′, {X}p′, {X}p′ in FIGS. 16-18) can optionally be related to a semantic. Such semantics are frequently called by metaphorical terms such as “health index” or “operation status”. In the example with the motor, {X}′ has been obtained by aggregation and would be rather a “motor problem index” that symbolizes a potential malfunction of one machine component (i.e., a particular motor). In that sense, {X}′ does not yet show a critical parameter CR (in the sense as used for the method 400/401 described above), but may let the computer find the (root) cause faster (cf. the scenario with the broken bearing). In other words, {X}′ may show CR at relatively low accuracy, but accurate enough to let the computer further investigate the motor (and the components that interact with the motor), and not yet to investigate components. {X}′ allows prioritizing, thus saving computation resources.

In the example of FIG. 16, the presence of absence of fire (in a furnace or similar machine) at certain time points may be indicative of the status of the machine and may be used as a pointer to normal (or abnormal) operation.

### Pre-Processing as a Method Step

Pro-processing can be summarized in view of method 400/401. The step receiving 410 the first multi-variate time-series 501, {{X}}_op and obtaining 420 the second multi-variate time-series (502, {{X}}_rf) can be enhanced by generating at least a sub-set of at least one single-variate time-series ({X}p′, {X}q′, {X}′) with parameter samples 505 by pre-processing data.

As explained for FIGS. 16-18, generating can follow any of the following approaches:
(a) The computer can process images 281 to assign numerical values to the parameter samples 505 of at least one single-variate time-series {X} p.
(b) The computer can process images 281 with identifying content areas 282, 283 within the images 281 and with assigning numerical values for the areas separately. The computer thereby generates a sub-set with at least two single-variate time-series {X}p′, {X}q′.
(c) The computer can process sounds to assign numeric values to the parameter samples, of at least one single-variate time-series {X} p.
(d) The computer can aggregate at least two single-variate time-series of the first or second multi-variate time-series 501, 502 to a single-variate time-series {X}p′. The computer would actually perform aggregation for both series separately, one aggregation for the first one (“op”), and one for the second one (“rf”). Re-using aggregation results is possible, for “rf”.

The computer can implement the approaches by adapter 280 or otherwise.

### Generic Computer

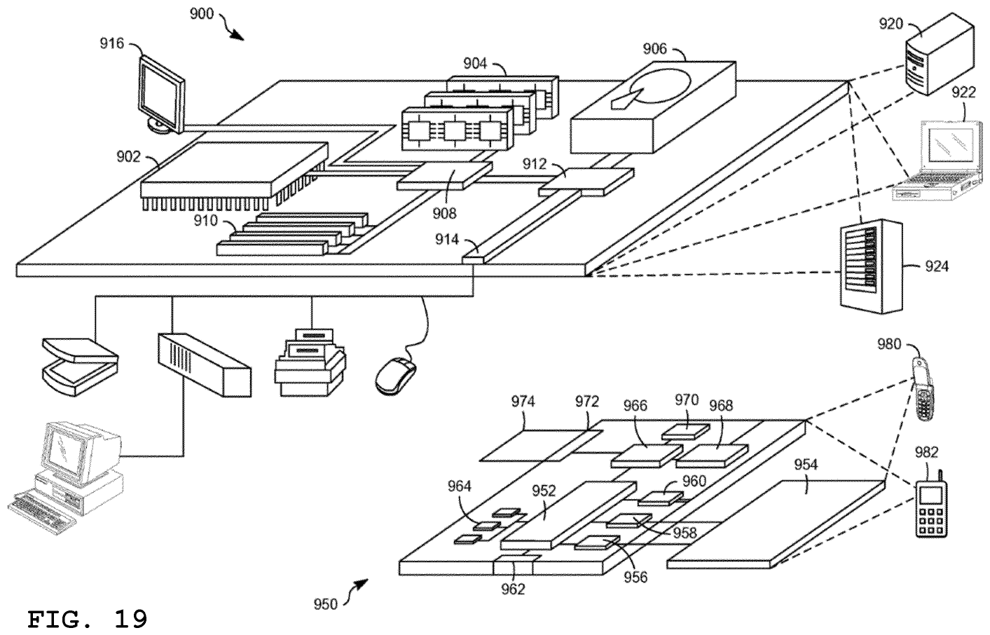

FIG. 19 illustrates an example of a generic computer device which may be used with the techniques described here. FIG. 9 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Generic computer device may 900 correspond to the computer system 100 of FIG. 1. Computing device 950 is intended to represent various forms of mobile devices, such as personal digital assistants, cellular telephones, smart phones, driving assistance systems or board computers of vehicles and other similar computing devices. For example, computing device 950 may be used as a frontend by a user (e.g., an operator of a blast furnace) to interact with the computing device 900. The components shown here, their connections and relationships, and their functions, are meant to be exemplary only, and are not meant to limit implementations of the disclosures described and /or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and /or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and /or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and /or object-oriented programming language, and /or in assembly/machine language. As used herein, the terms “machine-readable medium” and “computer-readable medium” refer to any computer program product, apparatus and /or device (e.g., magnetic discs, optical disks, memory, Programmable Logic Devices (PLDs)) used to provide machine instructions and /or data to a programmable processor, including a machine-readable medium that receives machine instructions as a machine-readable signal. The term “machine-readable signal” refers to any signal used to provide machine instructions and /or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method for differentiating parameters of a particular industrial machine, with identifying a subset of parameters to be one or more critical parameters that cause abnormal operation of the particular industrial machine and /or that indicate one or more further parameters that cause the abnormal operation, wherein a computer processes multi-variate time-series, being pluralities of single-variate time-series that represent the parameters of the particular industrial machine, the method comprising the following steps:
receiving a first multi-variate time-series that represents an operation of the particular industrial machine;
obtaining a second multi-variate time-series that has representative samples in correspondence to the first multi-variate time-series, with a variate correspondence and with a time correspondence;
identifying , in the first multi-variate time-series , at least two deviating segments in that samples deviate from expected values;
for a number of activities that apply activity-specific replacement variations:
selecting one or more of the identified deviating segments according to a particular replacement variation included in the activity-specific replacement variations,
replacing the selected one or more identified deviating segments by the corresponding one or more segments of the second multi-variate time-series , to obtain a corrected first multi-variate time-series,
determining an error value that is a sum of:
a first error component that is related to the corrected first multi-variate time-series and to the second multi-variate time-series, and
a second error component that is related to the corrected first multi-variate time-series and to the first multi-variate time-series;
determining the particular replacement variation for the determined error value that has its lowest value;
selecting, for that the particular replacement determined variation , one or more variates associated with the previously selected one or more deviating segments as one or more variates that represent the one or more critical parameters; and
providing an identification of the one or more critical parameter to an operator of the particular industrial machine.

2. The method according to claim 1, further comprising determining the error value with the first error component comprises a sum of squared differences between the corrected first multi-variate time-series and the second multi-variate time-series, and the second error component comprising an absolute value of a linear difference between the corrected first multi-variate time-series and the first multi-variate time-series.

3. The method according to claim 1, further comprising determining the error value with the first error component comprises a sum of a number of time-slots, wherein the corrected first multi-variate time-series and the second multi-variate time-series are different.

4. The method according to claim 3, wherein the computer determines (443) the error value (443) with the first error component comprising the sum of the number of time-slots for single-variates time-series ({X}ϕ) in that the values are binary.

5. The method according to claim 1, further comprising determining the error values with the first error component, the first error component including a number of corrections in the corrected first multi-variate time-series.

6. The method according to claim 5, wherein the computer determines (443) the error value with the sum of the number of time-slots in that the corrections had been applied by replacing (442) binary values.

7. The method according to claim 1, wherein the first error component comprises a first weight factor and the second error component comprises a second weight factor.

8. The method according to claim 7, wherein the first and second error components each further comprise variate-specific weight factors , wherein the variate-specific weight factors include: a first group of variate-specific weight factors that are specific to variates that represent modifiable parameters; and with a second group of weight factors that are specific to variates that represent non-modifiable parameters.

9. The method according to claim 1, wherein the one or more critical parameters are cause-of-abnormal-operation parameters.

10. The method according to claim 1, further comprising identifying the at least two deviating segments in the first multi-variate time-series by applying a pre-defined rule, the pre-defined rule selected from a group comprising:
separately for each variate , comparing the single-variate time-series of the first and second multi-variate time-series and identifying deviating segments as segments, wherein corresponding samples have a value difference exceeding a pre-defined threshold;
separately for each variate , comparing the single-variate time-series of the first and second multi-variate time-series and identifying deviating segments as segments, wherein corresponding samples have a value difference, and wherein in that an integral of the value difference exceeds a pre-defined threshold integral; and
separately for each variate , comparing the single-variate time-series of the first and second multi-variate time-series and identifying deviating segments according to deviations between a starting time interval of the deviating segments and an ending time interval of the deviating segments.

11. The method according to claim 1, further comprising identifying the at least two deviating segments by processing the first multi-variate time-series by a pre-trained auto-encoder module that establishes a reconstruction of the first multi-variate time-series so that the reconstruction of the first multi-variate time-series takes over a function of the second multi-variate time-series.

12. The method according to claim 1, further comprising obtaining the second multi-variate time-series by processing the first multi-variate time-series by a pre-trained auto-encoder module that establishes a reconstruction of the first multi-variate time-series so that the reconstruction of the first multi-variate time-series takes over a function of the second multi-variate time-series.

13. The method according to claim 12, wherein processing the first multi-variate time-series by the pre-trained auto-encoder module comprises using a use a convolutional auto-encoder.

14. The method according to claim 1, wherein obtaining the second multi-variate time-series is performed by processing historical multi-variate time-series.

15. The method according to claim 1, wherein obtaining the second multi-variate time-series is performed by any of the following operations:
obtaining data from physically the same machine from different time periods;
obtaining data from a second machine that is similar to the particular industrial machine;
obtaining data from a virtualized machine;
obtaining data from an auto-encoder module as a reconstruction of the first multi-variate time-series; and
applying pre-defined rules.

16. The method according to claim 1, further comprising updating the second multi-variate time-series for repetitions of the steps of: the identifying in the first multi-variate time-series, the selecting one or more of the identified deviating segments, the replacing the selected one or more identified deviating segments, and the determining the error value.

17. The method according to claim 1, wherein receiving the first multi-variate time-series and obtaining the second multi-variate time-series comprises to generate at least a sub-set of at least one single-variate time-series, with parameter samples by pre-processing data according to any of the following operations:
(a) processing images to assign numerical values to the parameter samples of at least one single-variate time-series;
(b) processing images with identifying content areas within the images and assigning numerical values for the content areas separately to generate a sub-set with at least two single-variate time-series;
(c) processing sounds to assign numeric values to the parameter samples, of at least one single-variate time-series; and
(d) aggregating at least two single-variate time-series of the first multi-variate time-series or the second multi-variate time-series to a single-variate time-series.

18. A computer program product which, when loaded into a memory of a computer system and executed by at least one processor of the computer system, causes the computer system to perform steps of a computer-implemented method according to claim 1.

19. A computer system comprising a plurality of modules which, when executed by the computer system, perform steps of a computer-implemented method according to claim 1.

20. Use of a computer system of claim 19 to differentiate parameters of a particular industrial machine to identify a subset of parameters that are critical parameters that cause the abnormal operation of the particular industrial machine.
